(19) United States
(12) Patent Application Publication
(10) Pub. No.: US 2025/0256258 A1
(43) Pub. Date: Aug. 14, 2025

(54) Method of Synthesizing an Engineered Adsorbent for Selective Extraction of Lithium

(71) Applicant: Chemetics Inc., Vancouver (CA)

(72) Inventors: Mitrajit Mukherjee, Fairfield, NJ (US); Vamsi M. Vadhri, North Arlington, NJ (US); Narendra Joshi, Jersey City, NJ (US)

(21) Appl. No.: 19/041,861

(22) Filed: Jan. 30, 2025

Related U.S. Application Data
(63) Continuation-in-part of application No. 18/884,104, filed on Sep. 12, 2024.
(60) Provisional application No. 63/553,098, filed on Feb. 13, 2024.

(51) Int. Cl. B01J 20/10

(52) U.S. Cl. CPC B01J 20/103; B01J 2220/4806

(57) ABSTRACT

The invention relates to methods for synthesizing an engineered adsorbent suitable for the selective extraction of lithium from brine solutions. The invention describes the advantages of introducing mixed metal oxides into the crystal lattice of anatase titania precursor. The invention offers significant advantages, including high adsorption capacity of the ion sieve, enhanced chemical stability of the sorbent, and higher lithium selectivity.

### CROSS REFERENCE TO RELATED APPLICATIONS

This application claims priority to U.S. Provisional Patent Application No. 63/553,098 filed 13 Feb. 2024 and U.S. patent application Ser. No. 18/884,104 filed 12 Sep. 2024 which is incorporated by reference as if copied in full below.

### INTRODUCTION

Lithium has been playing a vital role in the energy production economy in the past decades. Due to its low density (0.5 gm/cc), low electrode potential in the electrochemical scale (−3.045 V) and high specific heat capacity1,2, lithium is an ideal element to produce both primary (single-discharge) and secondary (rechargeable) batteries that are now extensively used in many fields such as aerospace, petrochemicals, nuclear power generation, etc3-5. With the rapid development of high-tech industries such as information technology, electric vehicles, and green energy, it is expected that the demand for lithium will continue to grow, thus raising the issue of the long-term supply of lithium. Therefore, accelerating the research and development of lithium extraction technologies possesses important economic value.

The main approaches to extracting Li from brines include conventional evaporation, precipitation, solvent extraction, adsorption, and emerging technologies such as electrochemical methods, membrane-based technologies, and reaction-coupled separation 31. The predominant factors that influence selecting a method for Li extraction are the practical applicability of the method, the co-existing contaminant multivalent cations (namely the Mg/Li mass ratio), and the effects of other competing co-existing ions, such as Na+, K+, etc. The conventional evaporation method is slow (i.e., a few months), requires multiple purification steps, and has low Li recovery efficiency (<50%). Solvent extraction methods are not sustainable since the organic solvents can corrode the process equipment, and solvent leakage pollutes the environment. Electrochemical, organic adsorption, and membrane-based technologies are plagued by high cost, high energy consumption, and poor material durability6. Of the methods listed, lithium adsorption by inorganic molecular sieves has the advantage of simplicity, has high lithium recovery, and suitability for liquid systems with complex composition.

The most promising method for DLE from brines is adsorption by metal oxides and hydroxides serving as lithium-ion sieves (LISs)8.9. This method is attractive due to its efficiency, product quality, low energy and resource consumption and cleanliness of the process. Furthermore, no further lithium purification is needed and this method is more environmentally friendly than solvent extraction or precipitation methods.

Lithium ion-sieve adsorbents (LISs) refer to lithium selective adsorbents with unique chemical structures and properties which are capable of extracting lithium from brines⁰. The adsorption method uses a highly selective adsorbent to adsorb Li⁺ in brines and even in streams less concentrated than brines. LIS are inorganic compounds in which template ions are introduced by redox or ion-exchange reactions and afterwards stripped from the structure in a process called elution. The resulting vacancies thus will be ion-specific for the target ions due to ion screening phenomena and memory effect^{43,44}. Adsorption differs from the ion exchange process, and lithium ions are separated selectively from aqueous solutions through physical or chemical adsorption interactions. In ion-exchange processes, an equal amount of exchangeable cations from the exchanger can be substituted by cations from the solution. All adsorption processes depend on pH, temperature, ion concentration in the solution, the structure and specific kinetics of the exchanger and its cation exchange capacity (CEC), the use of additives and contact time.

The preparation method of the adsorbents heavily influences the degree of crystallinity and other structural properties of the ion-sieves and consequently affects their lithium adsorption capacity, selectivity, and regeneration ability. The processes can be divided into two main classes: solid-state methods and soft chemical methods. Solid-state methods involve calcination and microwave combustion whereas soft chemical methods include those in which the compounds are dissolved in aqueous solutions: hydrothermal method, sol-gel, molten-salt synthesis, coprecipitation.

### BACKGROUND

The existing LISs can be classified into three major types according to chemical elements and structures: (i) lithium-aluminum layered double hydroxides (LDH), (ii) lithium manganese oxides-type (LMO-type) and (iii) the lithium titanium oxides-type (LTO-type).

LDH type: Lithium-aluminum layered double hydroxide (LDH) adsorbents have been successfully applied as lithium adsorbents from brine. Compared to the other adsorbents, their adsorption capacity is lower but they are still effective because of ease of lithium stripping via elution.

The layered structure of lithium dialuminate forms due to the insertion of lithium insertion in aluminum hydroxide. Especially, when lithium salts are inserted into γ-Al(OH)₃ (gibbsite), it results in compounds with the composition [LiAl₂(OH)₆]X*γH₂O with {X═Cl, Br, NO₃}. Dehydrating these by heating them to around 200° C. results in materials with a crystalline structure and ordered lamellar phases^{45,46}. These layered double hydroxides (LDHs) can be used to selectively extract lithium from complex chloride salts systems⁴⁸. The adsorption capacity of LDHs is reported to be around 8-10 mg_{Li} g⁻¹ Al₂O₃ within a working pH range of between 3 and 8⁴⁷. However, Li⁺ sorption capacities of up to 123 mg/g at alkaline pH have been reported for polymeric aluminum hydroxide⁸⁹. Sorption temperature over 30° C. did not have appreciable effects on the Li⁺ sorption capacity⁸⁹. These experiments also show that increased Li adsorption was observed with increasing pH and higher Li concentration in brine indicating that ion-exchange is the main mechanism. Li sorption studies from natural geothermal waters on amorphous Al-hydroxide revealed that the optimum sorption conditions of 90% Li recovery occur at 80° C., at pH >5 and an Al/Li ratio ˜3.5⁹⁰.

Paranthaman et al.⁷ synthesized LDH with different Li/Al molar ratios and found that LDH with a Li/Al molar ratio of 1:1.25 had the highest selectivity for lithium, and the extraction yield of lithium reached approximately 91%. Yu et al.⁸ and Chen et al.⁶ proposed magnetic double-layer hydroxide adsorbents (MLDH) combined with Fe₃O₄ to solve the difficult separation of LDH. They found that increasing Fe₃O₄ content from 13.11 wt % to 30.58 wt % resulted in a decrease in Li adsorption capability from 5.83 to 3.46 mg/g; however, it facilitated its separation and recovery. Additionally, the Mg/Li mass ratio in the desorption solution decreased from 6.37 to 2.10, indicating that increase of Fe₃O₄ improved the selectivity of the adsorbent for lithium.

Stripping these sorbents proved to be challenging as over-depletion of LiCl caused an irreversible degradation of the sorbent that went back to its precursor i.e. gibbsite structure^{7,49}. To avoid these issues another study suggested a low flow of deionized water as eluents⁵⁰.

LMO-type: LMO type ion sieves are the most investigated lithium-ion adsorbents. They are used in powder or composite forms. They have been most widely used because they show high lithium adsorption capacities, outstanding lithium selectivity and excellent regeneration performance. Of these, spinel-type sorbents are of particular interest as they reach high Li sorption capacities (up to 53.5 mg/g), high Li selectivity during sorption and stability^{91,92}. The sorption capacity as well as Li uptake increases with increasing temperature.

Commonly used desorption solutions are diluted mineral acids, such as HCl or HNO3. During this process, there was significant loss of manganese (Mn²⁺ ions) during the regeneration process with acid which led to degradation of ion exchange capacity and poor cycling stability. This key issue seriously limits LMO-type LISs potential for widespread application. To increase the chemical stability, transition metals (e.g. Sb, Ce, Cr, Cu, Co, Ni, Fe) can be incorporated into the framework during synthesis^{91,83}. Manganese-based adsorbents come in multiple possible stoichiometries such as LiMn₂O₄³, Li₂MnO₃⁴, and Li₄MnₛO₁₂⁵ all of which have been shown to be effective for lithium recovery.

LMO-type ion sieves extract lithium either via a redox mechanism or an ion exchange mechanism or a combination of both^{51,52}. In the case of ion-exchange mechanism, lithium ions are replaced by protons in the lattice structure. There are no changes Mn(III) and Mn(IV) sites or the oxidation state of Mn and the adsorption is pH dependent. There is no manganese dissolution in this mechanism and the spinel structure is retained along with the adsorption capacity. In the case of redox adsorption, the adsorption is not pH dependent. Lithium insertion and removal happens via the disproportionation of Mn(III) and Mn(IV) ions under acidic conditions. Mn(III) is predicted to diffuse to the surface and dissolve in the aqueous solution, whereas Mn(IV) will remain in the crystal structure. This explains the Mn dissolution and consequently the performance decrease, but not the pH dependence. However, since both pH dependence and Mn dissolution is observed, a combination of the two models has since been proposed in order to explain the experimental evidences⁵².

Based on pH titration and other crystallographic studies, it was concluded that LMO-type ion-sieves had three different types of sites^{53,54}: redox sites, where Mn(II) is oxidized in Mn(IV); Li⁺-specific insertion sites; nonspecific insertion sites. These studies also concluded that the relative quantities of the different types of sites depended on the preparation conditions. For instance, it was found out that at low temperatures (<500° C.), insertion sites were mainly formed, whereas redox sites were favored at higher temperatures⁵⁵.

The high Li selectivity of spinel-type LMO results from the adsorption of Li in tunnels in the Mn—O structure while sorption of competing ions is restricted to the sorbent surface^{91,83}. The Li⁺ sorption capacity generally increases with increasing pH (optimum at pH 12) and Li+ concentration⁹³. The adsorption capacity and chemical stability of LMO-type sorbents can be improved by changing the synthesis parameters such as combination with Al(OH)₃, using electrochemical techniques or doping with metals like iron⁹⁵, chromium⁹¹, or coating with CeO₂⁹⁴.

LMO-Type LIS in Powder Form: As previously stated, ion-sieves in powder form are not suitable for industrial applications. However, the powder form is used to investigate a sorbent's properties, conduct various process variable studies^{56,57} and determine its suitability for further development. Chitrakar et al. synthesized LMO type sorbents in different ways and concluded that the hydrothermally prepared sorbents are superior with an adsorption capacity of 35-40 mg_{Li} g⁻¹⁵⁸. Zhang et al., prepared nanorods of ß-MnO₂ via hydrothermal reaction followed by low-temperature calcination of the precursor Li₄Mn₅O₁₂⁵⁹. These nanorods showed an adsorption capacity of 34.7 mg_{Li}u g⁻¹ after 72 h at 30° C.

Granulated LMO Adsorbents: The most common way to make the powders more suitable for industrial setting and to give them mechanical stability is to form agglomerates using various methods. For this purpose several options are available such as polymeric binders like PVC⁶⁶, biobased binders such as chitin/chitosan or cellulose^{61,62,63}, or loading the active sorbent on inorganic structures⁶⁴⁻⁶⁵. Doing this increases the water permeability, reduces the dead volume and improves column flow properties. However, having a binder can also have adverse effects such as lower efficiencies than powder adsorbents, higher contact times to reach a thermodynamic equilibrium and inert volumes due to the aqueous solution not reaching the active sorbent material.

Foam-Type LMO Adsorbents: Although granulation can reach good adsorption performances, the problem of dead volume and the aqueous solution not being able to reach all the active material still exists. This limitation could be avoided using foams, which present a three-dimensional network. Foams are more flexible and are more easily handled compared to granulated adsorbents. However, they are usually more expensive to make and often release harmful substances^{67,68}. For instance, LIS have been successfully coupled with polyurethane template but the aqueous solution reached only a fraction of the active material in these sorbents⁶⁷. However, use of PVA with higher loadings of LMO yielded more positive results⁶⁸. More environmentally friendly binders such as aqueous agar solutions^{69,70} and dried crosslinked alginate composites incorporated with HMO ion sieves^{71,72} were also investigated and gave more encouraging results.

LMO Mixed-Matrix materials: Ion sieves can also be loaded as fillers in a polymeric phase like PVC and PVDF^{73,74}. These types of materials are called “mixed matrix membranes.” Efforts were made to keep the ion sieves content low to avoid surface defects. In the same class of materials, binders like Graphene oxide (GO)⁷⁵ and biobased recyclable materials like cellulose^{76,77} were also used for LIS. These materials presented superior mechanical and adsorption properties when compared to other adsorbents. Similarly, inorganic ion sieves can also be loaded as fillers onto electrospun nanofibers like polyacrylonitrile (PAN)^{78,79} and polysulfone (PSf)^{80,81}. These materials have minimal dead volume in the binder which is a primary cause for poor efficiency of composite sorbents.

LTO-type: Lithium titanium oxide ion sieves are, like the LMO-type, widely used selective adsorbents due to their high adsorption capacity, high stability and environmentally-friendly characteristics. The adsorption-desorption mechanism is believed to be ion-exchange between Li⁺ and H⁺ ions⁸⁷. Sorption kinetics of Ti-oxide sorbents are relatively slow, but increase with increasing temperature³⁰.

Lithium insertion into TiO₂ frameworks is well-documented and the different polymorphs can accommodate lithium in different stoichiometries. TiO₂ presents itself in different polymorphs, namely anatase, brookite, rutile, and TiO₂—B¹³. Lithium can be more easily inserted into anatase or TiO₂—B than in rutile. Lithium insertion into TiO2 frameworks is diffusion-controlled and depends on the channel length and the polymorph of TiO2^{14,15}. Additionally, the insertion capacity of lithium and the eventual stoichiometry of the various structures depends on crystal size of TiO₂ and the temperature of synthesis^{16,17}.

Despite the enormous number of possible stoichiometries of the LTO-type sieves, only Li₂TiO₃^{9,10} and Li₄Ti₅O₁₂^{11,12} have shown selective adsorption properties for lithium recovery. Numerous morphologies of the LIS were synthesized but till now the powder form is the most investigated for lithium recovery. Parameters like effect of calcination conditions and the polymorphs of titania precursors on the effectiveness for lithium recovery purposes were studied^{18,19,20,21}. For instance, Li et al. investigated the effects of crystal phases of the starting TiO₂ material on the adsorption performance of the resulting lithium adsorbents²². They prepared different LTO adsorbents by using amorphous, anatase and rutile TiO2 as titania sources and prepared LTO adsorbents with Li₂CO₃ via solid-state reaction. Among the three types of resulting HTO adsorbents, they found that anatase TiO₂-derived HTO exhibited the highest adsorption performance for Li⁺; due to its strongest hydrophilicity, it was the most favorable material (compared to those derived other polymorphs) for contacting with solutions containing Li⁺ and displayed the best Li⁺ adsorption capacity (34.2 mg/gm).

The LIS adsorbents are usually synthesized in powder form. They cannot be directly used for industrial column operation as beds of such fine particles offer significant resistance to flow during the dynamic adsorption process. If fluidized contactors are used, one must also consider the ease of separation of the adsorbents from the liquid after contacting; the smaller the particle size, the harder the separation is. Therefore, it is necessary to develop adsorbents for Li⁺ recovery with low flow resistance and easy separation. To solve this problem, various forms of composite adsorbents containing LIS have been developed to immobilize the LIS particles, such as spherical beads, mixed matrix membranes, porous foams, and polymeric binders^{23,24}. However, LTOs prepared by sol-gel method present a lower adsorption capacity, which was shown to further decrease by the presence of the ceramic foam³⁹.

Granulated adsorbents using binders were also tested. Zhang et al. calcined Li₂TiO₃ and polyvinyl butyral (PVB) together and reported LIS with a lithium adsorption capacity of 25 mg_{Li} g^{-125,26}. Granulated adsorbents with either PVC or agar as binders were also tested with geothermal brines at higher temperatures and slightly higher adsorption capacities were reached with agar as binder^{27,28}. Hossain et al. prepared LTO ion sieves with titania coming from dry sludge of a wastewater plant and reported good lithium adsorption (35 mg_{Li} g⁻¹) and selectivity properties²⁹. Other morphologies with LIS such as nanoribbons and nanotubes were investigated, that were able to reach impressive adsorption values of upto 160 mg_{Li} g^{-130,31,32}. Yolk-shell structured carbon microspheres with sea urchin-like Li₄Ti₅O₁₂ shell were also investigated³³. This adsorbent was reported as fast-acting reaching an equilibrium adsorption of 28.46 mg_{Li} g⁻¹ within 2 hrs. A 3D macroporous-mesoporous foam containing the spinel Li₄Ti₅O₁₂ with a closely-packed polystyrene microarray as hard template was recently reported^{40,41}. The ion sieve thus prepared showed excellent adsorption properties, reaching 38.24 mg_{Li} g⁻¹ in 24 h. This is much higher than the one reported by the same adsorbent in its non-porous form, which was only 7.77 mg_{Li} g⁻¹. As with LMO adsorbents, higher lithium adsorption capacities at higher pH were reported for LTO adsorbents too^{34,35}. Hydrochloric acid is the most used eluent to strip lithium from the LIS. However, other eluents like nitric acid and the more environmentally-friendly options such as persulfates of sodium and potassium have also been reported to be successful^{31,37,38}.

Multi-metal LIS adsorbents: Since each class of the ion-sieves described above has its own limitations, several attempts were made to either create hybrid LIS or dope existing LIS. Ryu et al.² combined the advantages of manganese-based and titanium-based adsorbents to prepare Li_{1.33}(Ti_{0.1}Mn_{0.9})_{1.67}O₄ composite adsorbents. The structure was more stable than that of a single manganese-based adsorbent, which effectively reduced the loss of manganese. Chitrakar et al. synthesized several magnesium-doped LMO and reported that both the chemical stability and the lithium adsorption capacity increased with increase in Mg:Mn ratio⁸². When the Mg:Mn ratio was 0.33, the lithium adsorption capacity was 23-25 mg_{Li} g⁻¹ and the dissolution of manganese decreased from 5.8 wt % to 0.25 wt %. Similar trend was observed with Fe-doped LMOs⁸³. Lithium adsorption increased with increase in Fe:Mn ratio and an adsorption capacity of 18.1 mg_{Li} g⁻¹ was observed when the ratio was equal to 0.1. Molybdenum-doped Ti-oxide is highly selective for Li and adsorbs up to 78 mg/g Li⁺⁸⁶. Similarly, superior LTO sorbents were prepared by doping with aluminum and zirconium^{84,85}.

Other inorganic sorbents: In addition to the three classes of inorganic sorbents described above, numerous other sorbents have also been investigated⁸⁸. Some of these other sorbents which have shown lithium uptake properties are iron-oxy hydroxides like goethite and lepidocrocite, lithium iron phosphates, clay minerals like kaolinite, montmorillonite, hectorite etc., zeolites like clinoptilolite and synthetic Na—X with polyacrylic acid, zirconium phosphate, Sn-antimonates, Sb-oxides, Ta-oxides, H₈Nb₂₂O₅₉ etc⁸⁸.

### PRIOR ART

Lithium rich sources such as geothermal brines involve complex chemistry with high salinity. There are many approaches to extract lithium from brines such as chemical precipitation, filtration using membrane, extraction using solvents, organic resign and polymer materials sorption and so forth. Many patent publications have demonstrated that lithium extraction from geothermal brines is technologically feasible, however developing economically and environmentally viable process remains challenging. In this regards, U.S. Pat. No. 10,322,950 B2 claimed that it has developed methods for extracting lithium from lithium ions containing solution via reversible cation exchange with H⁺. The method involved utilization of metal oxide or metalloid oxide cation exchange materials having an active sublattice that preferentially bound Li⁺ cations relative to H⁺ and Na⁺ in a brine solution and preferentially bound H⁺ relative to Li⁺ in an acid medium. The patent claimed that it developed a method for extracting lithium ions from a solution which included: first, contacting a sample solution containing lithium cations with hydrogenated cation exchange material, which would cause lithium cations to undergo cation exchange with hydrogen in the hydrogenated cation exchange material which would form lithiated cation exchange material; second, contacting formed lithiated cation exchange material with an acid solution upon which hydrogen ions in the acid solution would undergo cation exchange with lithium ions which would release lithium ions in the acid solution and at the same time it would regenerate the hydrogenated cation exchange material; third, the method involved separating released lithium ions from the acidic solution. The patent claimed that the lithiated cation exchange materials included Li₂MnO₃, Li₄TiO₄, LiAlO₂, LiCuO₂, Li₂SnO₃, Li₂FeO₃, Li₃VO₄, Li₂SiO₇ and so forth. Accordingly, the patent suggested that the cation exchange materials could be in powders, films or membranes forms. The authors of this patent claimed that they tested 77 Li-M-O (M=al, B, Cu, Fe, Ga, Ge, Mn, Sc, Si, Sn, Ti, V, Y, Zn, Zr) compounds using density functional theory and specific ion interaction theory to identify ion exchange materials for lithium extraction from brines and seawater and found that 9 compounds: LiAlO₂, LiCuO₂, Li₂MnO₃, Li₄Mn₅O₁₂, Li₂SnO₃, Li₄TiO₄, Li₄Ti₅O₁₂, Li₇Ti₁₁O₂₄, and Li₃VO₄ are the most suitable for large scale Li extraction from brines. Most other compounds were not suitable for lithium extraction because they either bind lithium (Li) in both brine and acid or bind hydrogen (H) in both acid and brine.

U.S. Pat. No. 10,434,497 B2 also disclosed synthesizing inorganic sorbents for lithium extraction from natural and technological brines. The synthesis of the sorbent consisted of contacting soluble niobate with an acid in the presence of zirconium salt which resulted to precipitate of a mixed hydrated niobium and zirconium oxide. The ratio of atomic niobium/zirconium taken to be 1:(0.1 to 0.7). Lithium form of mixed hydrated niobium and zirconium oxide was obtained by treating with a solution of LiOH and Li₂CO₃ respectively which was calcined at 450 to 600° C. The hydrogen form of sorbent solution was obtained by treating with an acid solution (HNO₃). The patent disclosed the comparison of capacities of the sorbents prepared by the method of invention and conventional methods. It disclosed that the sorption was carried out from a solution containing Li₂SO₄, NaCl, and NaOH having a pH of 12. The patent claimed that the lithium adsorption capacity of the invention was nearly double (2.45 mg/gm) that of the conventional method (1.42 mg/gm) for the test conducted with model solution; similarly, Li—Na separation coefficient was 49 for the invention and 38 for the conventional method. Similarly, the patent claimed that the sorbent test conducted with real natural brines provided almost three times higher absorption capacity for the invention compared to the conventional sorbent (2.55 mg/gm vs 0.87 mg/gm). Hence, the patent claimed that the sorbent obtained by the method of the invention was suitable for industrial production of lithium by extraction from complex natural and technological brines.

In another U.S. Pat. No. 10,439,200B2, the inventors claimed the coated ion exchange particles for the extraction of lithium from brine consisting of a solution of 50,000 ppm Na and 1,000 ppm Li. The patent described that the coated ion exchange particles comprised of 98% Li₄Mn₅O₁₂ and 2% coating material ZrO₂ which was treated with HCl to obtain hydrogen rich composition. The ZrO₂ coating allowed diffusion of hydrogen and lithium respectively to and from the active material. The patent mentioned the elemental analysis of lithium uptake however it did not provide the analysis results.

U.S. Pat. No. 4,159,311 disclosed a novel composition consisting of anion exchange resin containing LiX·₂Al(OH)₃ dispersed within the resin particles. The patent disclosed a process of synthesizing LiX·₂Al(OH)₃ resin by contacting the anion exchange resin containing Al(OH)₃ dispersed within the resin with a brine which contained Li⁺ but no Mg²⁺ and heating thereby forming a microcrystalline form of LiX·₂Al(OH)₃. The patent described that to remove Li⁺ in the form of LiX (X being halides), water containing small amount of LiX was eluted through the resin, and the process was repeated to remove more Li⁺ from brine including brine which contained Mg²⁺ and the temperature was maintained at 85-90° C. The patent claimed the Li+ removal and recovery of 57.9 mg or 39.5% on the resin.

Patent CN101944600A disclosed the invention of lithium ion sieve adsorbent consisting of Lithium-titanium oxide type and a method of preparation for absorbing enriched lithium from salt lake brine, seawater and other liquid lithium sources. The method of preparation of adsorbent described in the patent was such that titanium dioxide and lithium salt were mixed, ground by a ball mill, followed by drying and calcining to obtain Li₂TiO₃ ion sieve which was treated with inorganic acid to obtain H₂TiO₃ ion exchange material. The patent disclosed a details of cation exchange material such that titanium oxide and lithium precursor such as LiOH, Li₂CO₃ were mixed with Li/Ti: (1-3)/1 in the presence of ethyl alcohol or acetone, followed by grinding in ball grinder for 1-8 hr at room temperature to 100° C., drying for 4-24 hours, and calcined at 550-800° C. for 4 to 12 hours. The obtained Li₂TiO₃ is treated with HCL/HNO₃/H₂SO₄ having concentration of 0.01-2 mol/L. The patent claimed the adsorption capacity of the invention could reach more than 14 mg Li+/gm absorbent.

Patent CN113548701A disclosed the invention related to the method of preparing aluminum, cobalt, and nickel co-doped manganese lithium ion sieve by taking a waste ternary lithium ion battery anode material as a source of lithium. The patent claimed the lithium adsorption capacity of the adsorbent to be 15-21 mg/gm measured in 0.5 g/L lithium chloride aqueous solution and the manganese dissolution rate after 10 cycles of adsorption and desorption was 0.8%-1%.

Although LTO adsorbents are more stable than LMO adsorbents, they also experience a loss of capacity. This capacity loss is typically attributed to the dissolution of Ti⁴⁺ ions in acid during the lithium recovery process, an effect that has been documented in the literature.

Ivanets et al. synthesized Li₄Ti₅O₁₂ and Li₂TiO₃ using a solid-state synthesis method and evaluated their potential as adsorbents for lithium extraction¹⁴¹. Lithium carbonate (Li₂CO₃) and titanium dioxide (TiO₂, both anatase and rutile phases) were employed as lithium and titanium sources, respectively. The conversion of Li₄Ti₅O₁₂ to HTO (hydrogen titanate) demonstrated a high conversion rate, ranging from 80% to 100%, depending on variables such as temperature, HCl concentration, and duration of exchange. However, the lithium adsorption capacity consistently decreased from 80 mg/g to 35 mg/g for adsorbents synthesized using anatase TiO₂ after the third regeneration cycle. A similar decline was observed for adsorbents synthesized using rutile TiO₂. This decrease in capacity was attributed to the destruction of the crystalline structure during repeated adsorption-desorption cycles. Ji et al. investigated the adsorption and elution capacities of lithium ion sieve Li₂TiO₃ (LTO), synthesized via a solid-state synthesis method¹⁴². The LTO was eluted using 0.8 M sodium persulfate. During lithium extraction, the ion sieve's adsorption capacity reached a maximum of 25 mg/g within one hour and remained nearly constant thereafter. However, the lithium adsorption capacity decreased in subsequent cycles, reducing to approximately 19 mg/g by the third cycle. The authors attributed this instability to the loss of titanium during each cycle.

Qian et al. synthesized a series of HTO powder and HTO/cellulose aerogel (HTO/CA) and examined their cyclic lithium extraction/elution performance from seawater¹⁴³. The HTO/CA exhibited a higher adsorption capacity of 29 mg/g in the first cycle; however, after five cycles, the capacity decreased to 23 mg/g. A similar trend was observed for HTO powder, where the degradation of adsorption capacity was more pronounced. The loss of capacity was ascribed to titanium loss during acid treatment and structural loosening due to repeated adsorption/desorption cycles under alkaline and acidic conditions.

Zhao et al. fabricated Li₄Ti₅O₁₂ (LTO) by first adding anatase TiO₂ to a 10 M NaOH solution and drying the mixture in an autoclave at 150° C. to obtain a white powder¹⁴⁴. This powder was then treated with 0.1 M HCl until the pH reached neutral. The titanium oxide obtained was dispersed in a 0.8 M LiOH aqueous solution, dried, and calcined at 550° C. for 6 hours to produce Li₄Ti₅O₁₂ nanorods. These nanorods were subsequently treated with 0.2 M HCl to form H₄Ti₅O₁₂ nanorods. Regeneration capabilities were assessed over five sequential adsorption/desorption cycles, revealing a roughly 10% decrease in adsorption capacity after the fifth cycle.

U.S. Pat. No. 10,695,694 B2 disclosed a method for synthesizing coated ion exchange particles for lithium extraction from natural and technological brines. The patent describes coated ion exchange particles designed to improve the extraction and processing of lithium from liquid resources. These particles feature a core of ion exchange material, such as lithium manganese oxide (Li₄Mn₅O₁₂) or lithium titanium oxide (Li₂TiO₃), coated with materials like zirconium dioxide (ZrO₂) or silicon dioxide (SiO₂). The inventors claim that the coating serves multiple functions: it prevents the dissolution and degradation of the ion exchange material, allows the use of concentrated acids to enhance lithium-ion extraction, and enables efficient diffusion of ions between the coated particles and liquid resources. The particles are used in a variety of methods, including column operations for lithium extraction, where the coating ensures that the ion exchange material remains effective throughout multiple cycles of ion uptake and release.

### SUMMARY OF THE INVENTION

In a first aspect, the invention provides a method of synthesizing an engineered adsorbent for the selective extraction of lithium ions from liquid brines comprising a sorbent composition having the chemical formula Li_{A}Ti_{B}Si_{C}O_{D}, comprising: combining a silica source with a lithium salt, a dopant stabilized titanium dioxide and water to form a slurry, drying to form a solid and calcining the solid to obtain a Lithiated adsorbent precursor, and either comprising the steps of either: a. adding an inorganic binder to the Lithiated adsorbent precursor to form a slurry, extruding the slurry to produce pellets, drying and calcining to form calcined pellets, and acid washing the calcined pellets to obtain an active H-form of the adsorbent. or b preparing an organic solution with an organic polymeric binder, making a slurry of the Lithiated adsorbent precursor with the organic solution; adding the slurry into deionized water to obtain porous composite; and acid washing the porous composite to obtain the active H-form of the adsorbent.

In any of the inventive aspects, the invention can be characterized by one or any combination of the following: wherein the source of lithium is one or a combination of two or more of lithium carbonate, lithium hydroxide, lithium sulfate, lithium chloride, lithium acetate, lithium propionate, lithium nitrate, lithium hydroxide monohydrate, lithium acetate dihydrate and lithium oxalate; wherein the dopant for stabilizing Titanium Dioxide is selected from a cation group of cerium (Ce), lanthanum (La), dysprosium (Dy), erbium (Er), aluminum (Al), barium (Ba), calcium (Ca), strontium (Sr), niobium (Nb), iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or mixtures thereof; wherein the source of silica comprises one or more of: organosilicon compounds (such as tetramethyl orthosilicate (TMOS), tetraethyl orthosilicate (TEOS), tetrabutyl orthosilicate (TBOS), methyltrimethoxysilane (MTMS), vinyltrimethoxysilane (VTMS), and phenyltrimethoxysilane (PTMS)), fumed silica, colloidal silica, suspensions of colloidal silica such as Ludox, sodium silicate, silicic acid, precipitated silica, pyrogenic silica, rice husk ash, fly ash, silica gel, zeolites, siliceous sand, amorphous silica, biogenic silica, mesoporous silica, silicate minerals (such as kaolin, bentonite, and talc), quartz, glass, diatomaceous earth, volcanic ash, natural silica-rich rocks (like granite), synthetic silicates or mixtures thereof; wherein the inorganic binder is selected from: alumina (Al₂O₃), silica (SiO₂), zinc oxide (ZnO), and zirconia (ZrO₂), or mixtures thereof; wherein the organic polymeric binder is selected from a list of polymers or co-polymers like PVB (Polyvinyl butyral), EVA (Ethylene-vinyl acetate), PMMA (Polymethyl methacrylate), PVC (Polyvinyl chloride), PET (Polyethylene terephthalate), PU (Polyurethane), PE (Polyethylene), ABS (Acrylonitrile-butadiene-styrene), PS (Polystyrene), PP (Polypropylene), PC (Polycarbonate), PTFE (Polytetrafluoroethylene), ETFE (Ethylene tetrafluoroethylene), PA (Polyamide/Nylon), PEEK (Polyether ether ketone), PLA (Polylactic acid), PPS (Polyphenylene sulfide), POM (Polyoxymethylene), PVDF (Polyvinylidene fluoride), SAN (Styrene-acrylonitrile copolymer) or mixtures thereof where the binder amount varies from 5 to 50 wt % of the adsorbent; wherein A ranges from of 1 to 5; wherein B ranges from of 1 to 6; wherein C ranges from of 1 to 3; wherein D ranges from of 4 to 20; wherein the volume average pore diameter of the adsorbent is in the range of 3-1000 nanometers; wherein the number average particle diameter of the adsorbent is in the range of 1-3 mm; wherein the BET surface area is at least 15 m²/g; wherein the calcining is conducted at a temperature greater than 550° C. The dopant stabilized titanium dioxide can be prepared using a sol gel procedure wherein precursors of a titanate and the dopant are first dissolved in an organic solvent, hydrolyzing the gel using either an aqueous solution of mineral acid or base to obtain a solid precipitate, drying and calcining the resultant solid precipitate to obtain a doped titania precursor, wherein the precursors of titanium are titanium alkoxides; wherein the precursors of dopants are alkoxides of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) and silicon (Si) or mixtures thereof. Alternately dopant stabilized titanium dioxide can be synthesized using a hydrothermal procedure wherein water-soluble salts of titanium and Dopants are first dissolved in water, co-precipitating the salts from the solution using a precipitating agent, drying and calcining the resultant solid precipitate to obtain the doped titania precursor, wherein the water-soluble salts of titanium are selected from: titanium(IV) tetrachloride, titanium(IV) sulfate, titanium(III) trichloride, titanium nitrate, Potassium hexafluoro-titanate(IV), Ammonium bis(oxalate) oxotitanate(IV), or combinations thereof; wherein the water-soluble salts of dopants are chloride, sulfate or nitrate salts of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) and silicon (Si) or mixtures thereof.

Materials characterized by mesoporous structures, featuring pore dimensions ranging from 2 nm to 50 nm, exhibit notable attributes such as elevated specific surface areas, substantial pore volumes, and adjustable pore sizes. These characteristics position them as optimal candidates for integration into lithium adsorption systems, given their abundant active sites and enhanced efficiency in transporting reactants. Mesoporous adsorbents can be synthesized wherein a biomorphic template is added to the binder during adsorbent synthesis to generate a mesoporous solid; wherein biomorphic templates are selected from one or a combination of two or more of xylose, glucose, cellobiose, oligomer of C5-C6 sugars, cellulose, soluble starch, sorghum straw and microalgae.

In another aspect, the invention provides a method for preparing an engineered adsorbent material for the extraction of lithium ions from liquid brines comprising a sorbent composition of the general formula (EA)(SD)(SM) wherein a. EA, the engineered adsorbent, is the active material which has a composition with a chemical formula LiaHbTicOd, wherein a is in the range of 0 to 5, b a is in the range of 0 to 5, c is in the range of 1 to 8, and d is in the range of 1 to 12; b. SD is the stabilizer dopant to inhibit the anatase to rutile transition of the titania precursor; and c. SM is the support material comprising of metal oxides or mixtures thereof to provide mechanical stability, and improved flow characteristics of the liquid phase, and comprising the steps of impregnating anatase titanium dioxide particles with salts of Stabilizer Dopant, drying and calcining the resultant solid to obtain the doped titania precursor, mixing an inorganic support with a lithium salt and doped titania precursor; drying and calcining the resultant solid to obtain the adsorbent precursor; and acid washing the adsorbent precursor to obtain the active H-form of the adsorbent; or
impregnating anatase Titanium Dioxide particles with salts of Stabilizer Dopant; drying and calcining the resultant solid to obtain the doped Titania precursor; preparing an organic solution with polymeric binders; making a slurry of doped Titania precursor with the organic solution; injecting the slurry dropwise into deionized water to obtain porous spherical composite; and acid washing the adsorbent precursor to obtain the active H-form of the adsorbent.

The invention can be further characterized by one or any combination of: a) Lithium Adsorption Capacity >10 kg/ton Adsorbent, using a test where the engineered adsorbent is exposed to a brine solution for a period of 24 hrs at room temperature containing Lithium ions with a concentration >500 ppm such that the adsorbent loading is 2 wt % of the total solution, and the pH of the solution is adjusted to 8 b) by an XRD pattern displaying typical LTO peaks with prominent peak in the 20 range of 20° to 30°, indicative of an LTSO phase having a height (or integrated intensity) that is at least 15% of the largest LTO peak; wherein the active material is characterizable by a Lithium Adsorption Capacity >10 kg/1000 kg Adsorbent, using a test where the engineered adsorbent is loaded in a I liter reactor containing brine solution with a Lithium ion concentration of 500 ppm such that the pH is adjusted to 7 by adding a buffer salt. The test is conducted for 24 hrs and the brine solution analyzed for metals concentration; where the source of lithium is one or the combination of more than two of lithium hydroxide, lithium sulfate, lithium chloride, lithium acetate, lithium propionate, lithium nitrate, lithium hydroxide monohydrate, lithium carbonate, lithium acetate dihydrate and lithium oxalate; wherein the stabilizer dopant SD is selected from a cation group of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or from an anion group of carbon (C), nitrogen (N), sulfur (S), fluorine (F) and phosphorus (P) or from a metalloid group of boron (B) and silicon (Si), or from an oxide group of alumina (Al₂O₃), silica (SiO2), zinc oxide (ZnO), and zirconia (ZrO2); wherein the Support Material (SM) is selected from an oxide group of alumina (Al2O3), silica (SiO2), zinc oxide (ZnO), and zirconia (ZrO2); wherein the active sorbent contains 50 to 95% of the total weight of the adsorbent; wherein the lithium amount comprises 2% to 20% of the total weight of the adsorbent precursor; wherein the titanium amount comprises 10% to 50% of the total weight of the adsorbent precursor; wherein the stabilizer dopant comprises 0.1 to 20 or 1 to 15 or 2 to 10 or no more than 20 wt % of the total weight of the adsorbent; wherein the support amount varies from 5 to 50 wt %; wherein the volume average pore diameter of the lithium adsorbent is in the range of 3-1000 nanometers; wherein the number average particle diameter of the lithium adsorbent is in the range of 10-3000 microns; comprising the steps of using a sol gel procedure wherein the organic precursors of a titanate and the Dopant are first dissolved in an organic solvent, hydrolyzing the gel using either an aqueous solution of mineral acid or base to obtain a solid precipitate; drying and calcining the resultant solid precipitate to obtain the doped titania precursor; mixing an inorganic support with a lithium salt and dopant-stabilized titanium dioxide; drying and calcining the resultant solid to obtain the adsorbent precursor; and acid washing the adsorbent precursor to obtain the active H-form of the adsorbent; using a hydrothermal procedure wherein water-soluble salts of Titanium and Dopants are first dissolved in water, co-precipitating the salts from the solution using a precipitating agent, drying and calcining the resultant solid precipitate to obtain the doped titania precursor, mixing an inorganic support with a lithium salt and dopant-stabilized titanium dioxide; drying and calcining the resultant solid to obtain the adsorbent precursor; and
acid washing the adsorbent precursor to obtain the active H-form of the adsorbent; wherein the water-soluble salts of Titanium are Titanium(IV) tetrachloride, titanium(IV) sulfate, titanium(III) trichloride, titanium nitrate, Potassium hexafluoro-titanate(IV), Ammonium bis(15xalate) oxotitanate(IV); wherein the water-soluble salts of dopants are chloride, sulfate or nitrate salts of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) and silicon (Si) or mixtures thereof; wherein the adsorbent precursor is first converted to its active H-form and then mixed with an inorganic support, dried and then calcined, where the final calcination is conducted at a temperature greater than 450° C.; wherein a biomorphic template is added to the inorganic support during adsorbent synthesis to generate a mesoporous solid; wherein biomorphic templates are selected from one or a combination of more than two of xylose, glucose, cellobiose, oligomer of C5-C6 sugars, cellulose, soluble starch, sorghum straw and microalgae; wherein the active material is characterizable by a Lithium Adsorption Capacity >10 kg/1000 kg Adsorbent, using a test where the engineered adsorbent is loaded in a slurry reactor containing brine solution with a Lithium ion concentration >500 ppm such that the pH is adjusted to 7 by adding a buffer salt; where the source of lithium is one or the combination of more than two of lithium hydroxide, lithium sulfate, lithium chloride, lithium acetate, lithium propionate, lithium nitrate, lithium hydroxide monohydrate, lithium carbonate, lithium acetate dihydrate and lithium oxalate; wherein the stabilizer dopant SD is selected from a cation group of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or from an anion group of carbon©, nitrogen (N), sulfur (S), fluorine (F) and phosphorus (P) or from a metalloid group of boron (B) and silicon (Si), or from an oxide group of alumina (Al2O3), silica (SiO2), zinc oxide (ZnO), and zirconia (ZrO2); wherein the Support Material (SM) is selected from one or a combination of more than two of PVA, PVDF, Poly acrylamide, Poly acrylonitrile (PAN), Polyvinylidene fluoride (PVDF), Polyurethane (PU), and Polyvinyl butyral (PVB); wherein the active material contains 50 to 95% of the total weight of the adsorbent; wherein the lithium amount comprises 2% to 20% of the total weight of the adsorbent precursor; comprising the steps of using a sol gel procedure wherein the precursors of titanate and the Dopant are first dissolved in an organic solvent, hydrolyzing the gel using either an aqueous solution of mineral acid or base to obtain a solid precipitate, preparing an organic solution with polymeric binders, making a slurry of doped Titania precursor with the organic solution; injecting the slurry dropwise into deionized water to obtain porous spherical composite; and acid washing the adsorbent precursor to obtain the active H-form of the adsorbent; comprising the steps of using a hydrothermal procedure wherein water-soluble salts of Titanium and Dopants are first dissolved in water,
co-precipitating the salts from the solution using a precipitating agent, preparing an organic solution with polymeric binders, making a slurry of doped Titania precursor with the organic solution; injecting the slurry dropwise into deionized water to obtain porous spherical composite; and acid washing the adsorbent precursor to obtain the active H-form of the adsorbent; wherein the water-soluble salts of titanium comprise one or more of titanium(IV) tetrachloride, titanium(IV) sulfate, titanium(III) trichloride, titanium nitrate, Potassium hexafluoro-titanate(IV), and Ammonium bis(oxalato) oxotitanate(IV); and/or wherein the water-soluble salts of dopants are chloride, sulfate or nitrate salts of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) or zirconium (Zr) or silicon (Si) or mixtures thereof.

The invention includes any of the methods described herein. The method may be further characterized by ±10% or ±20% or ±30% of any of the conditions, properties and/or measurements described herein. The invention is further elucidated in the examples below. The invention may be further characterized by any selected descriptions from the examples or embodiments, for example, within +30%, 20% (or within ±10%) of any of the values in any of the examples, tables or figures and may include data selected from the tables and/or figures in any combination. All ranges are inclusive and combinable. For example, when a range of “1 to 5′ is recited, the recited range should be construed as including ranges “1 to 4”, “1 to 3”, “1-2”, “1-2 & 4-5”, “1-3 & 5”, “2-5”, any of 1, 2, 3, 4, or 5 individually, and the like.”

As is standard patent terminology, the term “comprising” means “including” and does not exclude additional components. Any of the inventive aspects described in conjunction with the term “comprising” also include narrower embodiments in which the term “comprising” is replaced by the narrower terms “consisting essentially of” or “consisting of.”

### BRIEF DESCRIPTION OF THE DRAWINGS

FIG. 1: Li⁺ extraction from model brine solution by adsorbents A-Q.

FIG. 2: Li⁺ extraction from model brine solution by adsorbents A, B, and C.

FIG. 3: Li⁺ extraction from model brine solution by adsorbents synthesized using Solid State, Sol-Gel, and Precipitation methods respectively.

FIG. 4: Initial elution of lithium from LTO form of adsorbent using 0.2M HCl at 80° C. for 24 hours.

FIG. 5: Initial elution of lithium from LTO form of adsorbent using 0.2M HCl at 80° C. for 24 hours.

FIG. 6. Adsorbent batch test reactor FIG. 7. Lithium adsorption curves at different temperatures as a function of run-time.

FIG. 8: Li⁺ extraction from model brine solution by adsorbents R, S, T, and V, synthesized using PVC, PVA, PVDF, and PVC-PEG respectively.

FIG. 9: Li⁺ extraction from model brine solution by adsorbents U, and W, synthesized using Polystyrene, and Polystyrene+PEG respectively.

FIG. 10: Stability tests of Li⁺ extraction from model brine solution by adsorbents R and X.

FIG. 11: XRD pattern of the various prepared adsorbents.

### DETAILED DESCRIPTION OF INVENTION

The solid-state reaction synthesis method of Li₂TiO₃ is typically conducted by contacting TiO₂ and a lithium source at 700° C. or higher temperatures. The resulting LTO is then eluted with mineral acids to obtain HTO which is the active adsorbent.

Titanium dioxide can be observed in three polymorphous modifications: anatase (tetragonal system), brookite (orthorhombic system), and rutile (tetragonal system)¹²⁷. Rutile boasts the highest thermodynamic stability. Anatase is produced via sulfate process and rutile by sulfate or chloride processes. Some titanium dioxide properties are heavily dependent on its crystallographic structure. Rutile is characterized by a higher density, atoms fraction in the structure, substantial hardness, and refractive index. While the pigment properties of rutile are superior to those of anatase, the latter is more suitable as a catalyst and a sorbent.

When titanium dioxide is heated, several physical and chemical processes take place. This is due to the crystal lattice expansion, recrystallization accompanied by the formation of rutile nuclei and the crystallites growth^{134,135}. When heated, hydrated TiO₂ is dried, dehydrated, and undergoes dehydroxylation and desulfurization. Simultaneously, crystallization, anatase crystals growth, as well as the anatase—rutile transformation occurs (ART). ART can happen in a wide range of temperatures 400-1100° C. ART is a nucleation and growth process^{134,135}. It is influenced by several factors such as TiO₂ preparation procedure, its particle size, calcination temperature and time, presence of ART promoters or inhibitors, and also by the presence of rutile nuclei. Rutile obtained through heating anatase and brookite generally contains large crystallites (100 nm or larger)¹³⁶. The increase in particle size is accompanied by a decrease in surface area, therefore large rutile crystallites are not particularly catalytically active. For the purpose of lithium extraction, preserving the surface area of the TiO₂ phase is critical to ensure that the adsorption capacity of Li⁺ is maintained at a high level.

The phenomenon of lithium intercalation into the tunnel structures of TiO₂ frameworks is widely recognized, and it is also known that various polymorphs can accept the monovalent cation in varying stoichiometric ratios. Most studies have ignored the effect of structure of TiO₂ precursor on the resulting LTO. Li et al. investigated the effects of crystal phases of the starting TiO₂ material on the adsorption performance of the resulting lithium adsorbents¹⁴⁰. They prepared different LTO adsorbents by using amorphous, anatase and rutile TiO₂ as titania sources and prepared LTO adsorbents with Li₂CO₃ via solid-state reaction. Among the three types of resulting HTO adsorbents, they found that anatase TiO₂-derived HTO exhibited the highest adsorption performance for Li⁺; due to its strongest hydrophilicity, it was the most favorable material (compared to those derived other polymorphs) for contacting with solutions containing Li⁺ and displayed the best Li⁺ adsorption capacity (34.2 mg/gm). Other studies have also concluded that it is easier to incorporate lithium into anatase compared to rutile, mainly due to the less distorted unit cell resulting from the intercalation process^{137,138,139}. These studies prove that the structure of TiO₂ precursors influences the properties of resulting LISs, making it a key technical parameter in the adsorption process. Hence, it is desirable to use anatase TiO₂ as the starting material and preserve its crystallinity to synthesize highly effective adsorbents. However, as mentioned above, anatase transforms irreversibly to rutile at temperatures greater than 600° C., raising a challenge in preserving the anatase structure during the synthesis process in order to produce highly desirable lithium adsorbents.

Dopants are an effective method for minimizing the anatase to rutile transformation¹²⁷. Various dopants have been shown to have a strong influence on phase transformation through the change in oxygen vacancies. The influence the additives exert depends on their nature, stability, distribution, and the amount used during the TiO₂ transformation. Particles of additives present on the titanium dioxide surface limit the growth of crystallites during the calcinations process and increase the temperature of the ART, whereas the ones dissolved in the TiO₂ bulk accelerate it. In the ART, rutile nucleates at the interface, on the surface and in the bulk. The predominant nucleation mode may change from interface nucleation at low temperature to surface nucleation at intermediate temperatures and to bulk nucleation at very high temperatures¹³³. The fraction of a particular mode depends on the particle packing and the calcination time. It has also been found that additives causing vacancy in the titanium dioxide anion sublattice (Li⁺, K⁺, Cu²⁺, Al³⁺) act as promoters of the ART, whereas additives reducing the number of vacancies (S⁵⁺, P⁵⁺, Nb⁵⁺) are responsible for its inhibition¹²⁷. Many different dopant species, including metal cations, nearly all non-metal anions, and noble metals, have been explored.

Cationic dopants: A wide range of positively charged dopants have been studied to explore their impact on the rate of the anatase-to-rutile transition. It has been proposed that cations with smaller atomic radii and lower valences expedite the transition to rutile by increasing the number of oxygen vacancies. This increase in vacancies is thought to occur due to the replacement of Ti⁴⁺ ions with cations that have lower valences^{103,104,105,106,107}.

Conversely, when cations with valences greater than 4 are assumed to substitute for Ti ions within the anatase lattice, this process results in the elimination of existing oxygen vacancies and the creation of Ti interstitials that possess the same or lower valences¹⁰⁸. These transformations can be understood by considering the resistance to change (via ionic transport) in the relatively large and inflexible oxygen sub lattice. This sub lattice significantly influences the structural stability and the ability to rearrange chemical bonds to form rutile.

Taking these factors into account, the assumption of substitutional solid solubility leads to the conclusion that smaller cations with valences below 4 should encourage the transformation from anatase to rutile, while larger cations with valences exceeding 4 should impede this transition.

Non-metal dopants: Introducing non-metallic elements and anion dopants has the potential to enhance the photocatalytic performance and modify the structural characteristics of titania. Oxygen substitution in the TiO₂ lattice has been achieved by utilizing different non-metals such as carbon (C), nitrogen (N), fluorine (F), phosphorus (P), and sulfur (S)^{109,110,111,112,113,114,115}. According to Raj et al.¹¹⁶, phosphates were found to decrease the crystallinity and crystallite size of TiO₂ by up to 50% and delay the anatase to rutile phase transition. Roy et al.¹⁰⁹ discovered that dopants affect the concentration of oxygen vacancies, which subsequently inhibit or accelerate phase transitions. Phosphorus, for instance, was found to inhibit the anatase to rutile phase transition by decreasing the oxygen vacancy concentration¹⁰⁹.
Transition and rare-earth metal dopants: Extensive research has been conducted on modifying the properties of TiO₂ by incorporating transition metal and rare earth metal dopants. Numerous metal cations, such as Cu, Ni, Co, Mn, Zn, Fe, Zr, Cr, V, Al, Ga, Sn, Sb, Nb, Mo, Ag, Ru, Rh, Re, Os, La, Ta, Ce, Nd, Sm, Eu, Gd, and Yb, have been investigated for this purpose^{117,118,119,120,121,122,123,124,125,126}. These dopants are utilized to alter the phase, increase the surface area, enhance stability, and modify the pore structure of titania. For instance, Sibu et al. found that incorporating lanthanum into the TiO₂ structure stabilizes the Ti—O bonds, resulting in the retardation of the anatase to rutile phase transition¹¹⁹. Li et al. discovered that higher concentrations of cobalt dopants in TiO₂ led to an increase in the number of oxygen vacancies, thereby increasing the amount of rutile phase¹²⁰. Bian et al. observed that surface lanthanum species prevented the collapse of mesoporous titania structures during thermal treatment and inhibited the formation of the rutile phase¹¹⁷. In comparison to the pure sample, doped samples remained in the anatase phase at higher calcination temperatures. Silicon, as found by Periyat et al.¹¹⁸, prevented grain growth and stabilized the anatase phase even at 1000° C. It reduced contact between Ti atoms and provided a framework on the TiO₂ surface, inhibiting structural changes. Additionally, the surface area increased with increasing silicon concentration. A pure TiO₂ sample had a surface area of 48 m²/g, while a 15 mol % Si-doped TiO₂ had a surface area of 187 m²/g.
Oxide dopants: Alumina, silica, and zirconia have been employed to stabilize anatase^{96,97,98,99,100}. It has been proposed that the stabilization of anatase by Al, Si, and Zr occurs through their occupation of interstitial positions within the lattice, resulting in a distortion of the anatase lattice and constraining the lattice from contracting during the transformation to rutile⁹⁸. Conversely, Yang and Ferreira have suggested that the observed decrease in lattice parameters when SiO₂ and/or Al₂O₃ are introduced indicates evidence of solid solubility¹⁰¹. Another investigation into the impact of SiO₂ doping on the lattice parameter of anatase¹⁰² has also indicated that Si⁴⁺ incorporates itself substitutionally, thereby reducing the lattice parameter of anatase (and forming interstitial Ti⁴⁺). It is conceivable that the lattice distortion induced by doping restricts ionic rearrangements in a manner akin to interstitial ions. Additionally, the presence of undissolved SiO₂, potentially in the form of a glassy phase at grain boundaries, has been suggested to impede diffusion and diminish interparticle contact within anatase, thus reducing the number of available sites for heterogeneous nucleation¹⁰².
The reactions involved in the extraction of lithium from brine are listed below.

| | | | |
|---|---|---|---|
| 1. HMeO + Li⁺ | [symbol] | LiMeO + H⁺ | Lithium Extraction |
| 2. LiMeO + H⁺ | [symbol] | LiMeO + Li⁺ | Lithium Elution |

Where Me is usually Ti, Al and/or Mn.
Of these, titanium-based sorbents are more effective because they are more robust to acid treatment during lithium recovery. However. traditionally used LTO adsorbents suffer from the following limitations—

Li₂TiO₃ is synthesized via a solid-state reaction by heating TiO₂ with a lithium source at temperatures above 700° C. The resulting LTO is then treated with mineral acids to produce HTO, which serves as an active adsorbent. Titanium dioxide can exist in three forms—anatase, brookite, and rutile—each with different properties. Anatase is preferred for lithium adsorption due to its superior catalytic and adsorbent qualities, but during the LTO synthesis process involving high temperatures, it is converted to rutile. This transformation results in a decrease in surface area and lithium adsorption capacity for reaction 1 (shown above), making it less effective.

Preserving anatase during synthesis is crucial for maintaining high lithium adsorption performance. To address this issue, we have come up with a novel method to preserve the anatase phase of TiO₂ by introducing suitable dopants which will preserve the anatase structure by inhibiting the anatase-to-rutile transformation. The dopants introduced into the TiO₂ lattice can influence this phase transformation by altering oxygen vacancies.

Introduction of Silica Conventional LTO sorbents suffer from deactivation due to the dissolution of Ti⁴⁺ ions during lithium recovery i.e. reaction 2 (shown above). U.S. Pat. No. 10,695,694 B2 disclosed a method for synthesizing coated ion exchange particles for lithium extraction from natural and technological brines. Although the above invention describes the use of acid-resistant coatings to protect the ion exchange material, it is important to note that mineral acids can still diffuse through these coatings. This diffusion can compromise the protection of the active material, as it may still be exposed to degradation or dissolution despite the presence of a protective coating. Hence, the active material is not fully shielded from the effects of mineral acids, potentially limiting the effectiveness of the coating in preserving the integrity of the ion exchange material. To address this issue, we have developed a more stable titanium-based sorbent by forming a new phase LTSO. This innovative approach prevents Titanium leaching and enhances the durability and performance of the sorbents.

Lithium-ion batteries (LIBs) are increasingly pivotal in energy storage, especially for electric vehicles^{1,2}. A promising anode material is lithium titanate (Li₄Ti₅O₁₂ or LTO), known for its zero-strain properties, which allow it to endure high charge/discharge rates without significant volume changes²⁻⁵. This stability gives LTO a long cycle life, making it suitable for high-performance applications. LTO also has a higher and flatter lithium insertion reaction voltage (1.55 V vs. Li⁺/Li), preventing the formation of lithium dendrites and the decomposition of the electrolyte, enhancing the battery's safety. However, LTO's low specific capacity (175 mAh/g) limits its energy density, which is crucial for LIBs.

To enhance LTO's capacity, researchers are exploring composites with high-capacity materials like silicon (Si). Silicon boasts an impressive specific capacity of 4200 mAh/g, which is significantly higher than LTO's. However, silicon's major drawback is its substantial volume expansion (˜300%) during charge/discharge cycles, leading to mechanical stress and potential degradation. To mitigate this, LTO/nano-Si composites have been developed. By adding nano-sized Si particles to LTO (in variations of 1%, 5%, and 10%), researchers have created anodes with improved capacity and stability⁶. The LTO-10% Si composite, for instance, achieved a capacity of 262.54 mAh/g, demonstrating better performance while maintaining near 100% coulombic efficiency.

In fabricating these composites, methods like sol-gel techniques have been employed to create core-shell structures, where Si is coated with layers of lithium silicate and LTO^{7,8}. This structure not only enhances the surface area but also improves the electrochemical kinetics due to the increased conductivity at the Si-LTO interface. Characterization techniques such as XRD, SEM-EDX, and TEM-EDX are used to analyze the structure and composition, while electrochemical tests like EIS, CV, and CD assess battery performance. These studies show that adding Si enhances conductivity and capacity, although the improvement in conductivity is modest.

Additionally, research has shown that composites like Si/LiTi₂O₄, synthesized via sol-gel methods followed by heat treatment, demonstrate excellent cycle performance with a retained capacity of 1100 mAh/g after 50 cycles⁹. However, this composite had a low initial coulombic efficiency of around 74.8%, which is a challenge that needs addressing. The porous structure of the Si/LiTi₂O₄ nanocomposite is crucial for its performance, as it provides channels for lithium-ion transport and buffers Si's volume expansion during cycling.

Another notable advancement is the development of a composite α-Si film/Li₄Ti₅O₁₂ synthesized via vacuum thermal evaporation¹⁰. This composite has shown better cycling performance than pure LTO within a voltage range of 1.0-3.0 V, although the vacuum thermal evaporation technique poses challenges for large-scale commercial applications.

Despite these advances, challenges remain, particularly concerning Si's volume expansion, which can lead to instability in the solid-electrolyte interphase (SEI) and reduced cycle life. To address these issues, various strategies have been explored, including using Si at the nanoscale (e.g., nanoparticles, nanowires) and creating Si composites with materials like graphene.

Building on the established use of silica in LTO for electrochemical applications, it is noteworthy that, to date, no one has explored the innovative approach of adding silicon to LTO for lithium extraction from brine. In the novel application described in this patent, silicon is introduced in an oxide form to the LTO, which enhances the sorbent's chemical stability and resistance to degradation by acid. The methods of incorporating silicon into LTO is also unique, employing a specialized technique that results in the formation of a new phase, LTSO.

In one aspect, the invention provides a method for synthesizing an adsorbent suitable for the extraction lithium from brine with a composition of the general formula LiₐTi_{b}Si_{c}0_{d}. where a ranges from 1 to 5, b from 1 to 6, c from 1 to 3 and d from 4 to 20.

The source of lithium can be, for example, lithium carbonate, lithium hydroxide, lithium sulfate, lithium chloride, lithium acetate, lithium propionate, lithium nitrate, lithium hydroxide monohydrate, lithium acetate dihydrate and lithium oxalate or mixtures thereof.

The source of silica can be, for example, organosilicon compounds (such as tetramethyl orthosilicate (TMOS), tetraethyl orthosilicate (TEOS), tetrabutyl orthosilicate (TBOS), methyltrimethoxysilane (MTMS), vinyltrimethoxysilane (VTMS), and phenyltrimethoxysilane (PTMS)), fumed silica, colloidal silica, suspensions of colloidal silica such as Ludox, sodium silicate, silicic acid, precipitated silica, pyrogenic silica, rice husk ash, fly ash, silica gel, zeolites, siliceous sand, amorphous silica, biogenic silica, mesoporous silica, silicate minerals (such as kaolin, bentonite, and talc), quartz, glass, diatomaceous earth, volcanic ash, natural silica-rich rocks (like granite), synthetic silicates or mixtures thereof.

In a further aspect, the invention provides sorbent composition comprising titanium oxide where the anatase phase is stabilized with optional metal dopants selected from the group of cerium (Ce), lanthanum (La), dysprosium (Dy), erbium (Er), aluminum (Al), barium (Ba), calcium (Ca), strontium (Sr), niobium (Nb)iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or mixtures thereof, wherein the metal dopant amount varies from 0 to 15 wt % or more specifically from 2-10 wt %.

In a further aspect, the invention provides sorbent composition comprising titanium oxide where the anatase phase is stabilized with optional non-metal dopants selected from the group of carbon (C), nitrogen (N), sulfur (S), fluorine (F) and phosphorus (P) or mixtures thereof, wherein the anion dopant amount varied from 0 to 15 wt %.

In a further aspect, the invention provides sorbent composition comprising titanium oxide where the anatase phase is stabilized with optional metalloid dopants selected from the group of boron (B) and silicon (Si), or mixtures thereof, wherein the metalloid dopant amount varied from 0 to 15 wt %.

In a further aspect, the invention provides sorbent composition comprising titanium oxide where the anatase phase is stabilized with optional metal-oxide mixtures selected from the group of alumina (Al₂O₃), silica (SiO₂), zinc oxide (ZnO), and zirconia (ZrO₂) or mixtures thereof, wherein the metal-oxide amount varies from 0 to 15 wt % or more specifically from 2-10 wt %.

Dopants can be introduced at various stages in the synthesis, i.e., in the initial formation of a sol, after formation of a TiO₂ precursor before calcination, or after obtaining a TiO₂ product. Dopants can be incorporated in several ways, for example, as mixed metal oxides, substitutional or interstitial doping, or as surface species. The preparation technique of doped anatase is critically important because it impacts on the degree of equilibration achieved. There are three general methods by which dopants can be combined with anatase: point contact, surface contact, and molecular level mixing. These are listed below in order of decreasing diffusion distance required for the dopant ions in order to enter the anatase lattice:
Dry mixing: this involves the blending of dry powders of anatase and dopant-bearing phases, such as oxides. Both large particle sizes and inhomogeneous mixing are associated with increased diffusion distances.
Wet impregnation: this method involves mixing dry anatase powder with a dopant-bearing solution, such as dissolved salts or metal-alkoxides.
Molecular-level mixing: this method offers the most intimate level of association and involves mixing of a soluble titanium-bearing compound, typically an organometallic, such as titanium isopropoxide, with a soluble dopant-bearing compounds in an organic or aqueous solution. This level of mixing often is obtained through the use of doped sol—gels or co-precipitation.

Doping methods that involve larger diffusion distances for the dopant compounds to enter the titania lattice may diminish the inhibiting or promoting effect of the dopant on the anatase to rutile phase transformation since this may take place before the dopant has entered the anatase lattice.

Ion exchange materials are typically in the form of a fine powder. In some embodiments small particle size of the fine powder minimizes the diffusion distance that Li⁺ ions must travel for the ion exchange. However, ion-sieves in powder form are not suitable for industrial applications. Fine particles or powders of the active ion-exchange materials are not suitable for flow systems due to clogging and high pressure drops. An additional significant hurdle in the extraction of lithium using inorganic ion exchange materials involves the dissolution and deterioration of these materials especially during acid washing to elute lithium.

In order to make the powders more suitable for industrial setting, give them mechanical stability, improve their flow characteristics and to protect them from degradation, they must be fortified by support material using various methods. Thus, the final form of lithium adsorbents consists of an ion exchange material and a porous binder which has a connected network of pores that enables liquid permeability at low pressure drops. This coating serves to safeguard the ion exchange material from dissolution during the processes of lithium elution in an acidic environment and other phases of the ion exchange procedure. Using porous forms of these binders allows easy flow characteristics while also allowing ion-exchange between Li⁺ and H⁺ thus enabling lithium extraction from brines.

The binder may comprise an inorganic material like an oxide, a phosphate, a nitride, or a carbide or combinations thereof. In some embodiments, the binder is selected from silica, silica alumina, alumina, zirconia, titania, zinc oxide, MoO₂, SnO₂, Nb₂O₅, AlPO₄, SiC, TiC, ZrC, ZrN, BN or mixtures thereof or the binder may comprise an organic polymer wherein, the polymeric binders are chosen from PVA, PVDF, Poly acrylamide, Poly acrylonitrile (PAN), Polyvinylidene fluoride (PVDF), Polyurethane (PU), and Polyvinyl butyral (PVB).

In one aspect, the invention provides a method of synthesizing a titania based adsorbent suitable for the extraction of lithium from brines comprising the steps of: combining a silica source with a lithium salt, a dopant stabilized titanium dioxide and water to form a slurry, drying to form a solid and calcining the solid to obtain a Lithiated adsorbent precursor, and either
comprising the steps of a). adding an inorganic binder to the Lithiated adsorbent precursor to form a slurry, extruding the slurry to produce pellets, drying and calcining to form calcined pellets, and acid washing the calcined pellets to obtain an active H-form of the adsorbent, or
b) preparing an organic solution with an organic polymeric binder, making a slurry of the Lithiated adsorbent precursor with the organic solution; adding the slurry into deionized water to obtain porous composite; and acid washing the porous composite to obtain the active H-form of the adsorbent.
   The drying process is carried out by at least one of spray drying, vacuum drying and forced air drying, the drying temperature is 80-300° C., and the drying time is 1-24 hours, so that the raw material mixture is obtained.

In the calcination process the raw material mixture is heated for 10 to 70 hours at 500 to 850° C., preferably 12 to 50 hours, to obtain the lithium adsorbent precursor.

The acid washing process uses a dilute mineral acid such as HCl or combination of two or more of hydrochloric acid, sulfuric acid, nitric acid, sulfurous acid, hypochlorous acid, malonic acid, formic acid, acetic acid, carbonic acid, propionic acid, citric acid, boric acid and persulfates of sodium or potassium of molarity between 0.05 to 0.5 M at a temperature between 25° C. to 90° C. to convert the adsorbent to its active form. The acid washing preferably involves soaking and stirring for 0.5-24 hours to obtain the lithium adsorbent.

Materials characterized by mesoporous structures, featuring pore dimensions ranging from 2 nm to 50 nm, exhibit notable attributes such as elevated specific surface areas, substantial pore volumes, and adjustable pore sizes. These characteristics position them as optimal candidates for integration into lithium adsorption systems, given their abundant active sites and enhanced efficiency in transporting reactants. In practice, ordered mesoporous architectures of lithium manganese oxides (LMOs) have already found application as materials in lithium-ion batteries. However, there is a scarcity of research on mesoporous HTOs with high specific surface areas concerning their efficacy in extracting lithium ions.

In recent years, there has been a growing interest in utilizing natural biomaterials, including but not limited to paper, wood, cotton, eggshell membranes, sorghum straw, butterfly wings, pollen grains, legumes, and microalgae, as templates for creating biomorphic advanced functional materials. The appeal of using these natural biomaterials stems from their inherent advantages. In comparison to artificially produced template materials, natural biomaterials exhibit hierarchically structured architectures and increased meso-porosity, a result of their prolonged genetic evolution and optimization. Additionally, they are abundant, diverse, cost-effective, and reproducible. The mesoporous lithium adsorbent can be prepared by combining the biomorphic template to a silica source with a lithium salt, a dopant stabilized titanium dioxide and water to form a slurry, drying to form a solid and calcining the solid to obtain a Lithiated adsorbent precursor

The invention is further elucidated in the examples below. In some preferred embodiments, the invention may be further characterized by any selected descriptions from the examples, for example, within ±20% (or within ±10%) of any of the values in any of the examples, tables or figures; however, the scope of the present invention, in its broader aspects, is not intended to be limited by these examples.

### EXAMPLES

### Example 1

LiNO₃ salt precursor was dissolved in distilled water followed by addition of anatase TiO₂ such that the molar ratio of Li to Ti was 2. The titania added lithium salt solution was continuously mixed while heating until it became a paste which was dried overnight at 120° C. and calcined at 700° C. for 4 hr. The adsorbent is designated as Adsorbent A.

### Example 2

LiOH precursor was dispersed in distilled water followed by addition of anatase TiO₂ such that the molar ratio of Li to Ti was 2. The titania added lithium hydroxide dispersion was continuously mixed while heating until it became a paste which was dried overnight at 120° C. and calcined at 700° C. for 4 hr. The adsorbent is designated as Adsorbent B.

### Example 3

The adsorbent was prepared as in Example 2 with the difference being that the lithium precursor used was LiCO₃ instead of LiOH. The adsorbent is designated as Adsorbent C.

### Example 4

Ce(NO₃)₃*6H₂O precursor containing 2.5 wt % cerium was dissolved in distilled water and added to anatase TiO₂ dropwise via incipient wetness technique, followed by drying and calcining at 500° C. for 4 hr to obtain 2.5 wt % Ce promoted TiO₂. Similarly, LiCO₃ precursor was dispersed in distilled water followed by addition of 2.5 wt % Ce promoted TiO₂ such that the molar ratio of Li to Ti was 2. The 2.5% Ce promoted titania added lithium hydroxide dispersion was continuously mixed while heating until it became paste which was dried overnight at 120° C. and calcined at 700° C. for 4 hr. The adsorbent is designated as Adsorbent D.

### Example 5

The adsorbent was prepared as in Example 4 with the difference being that the 5 wt % Ce was added to anatase TiO₂ instead of 2.5 wt %. The adsorbent is designated as Adsorbent E.

### Example 6

The adsorbent was prepared as in Example 4 with the difference being that the 10 wt % Ce was added to anatase TiO₂ instead of 2.5 wt %. The adsorbent is designated as Adsorbent F.

### Example 7

The adsorbent was prepared as in Example 4 with the difference being that the 15 wt % Ce was added to anatase TiO₂ instead of 2.5 wt %. The adsorbent is designated as Adsorbent G.

### Example 8

La(NO₃)₃*6H₂O precursor containing 2.5 wt % lanthanum was dissolved in distilled water and added to anatase TiO₂ dropwise via incipient wetness technique, followed by drying and calcining at 500° C. for 4 hr to obtain 2.5 wt % La promoted TiO₂. Similarly, LiCO₃ precursor was dispersed in distilled water for 30 minutes followed by addition of 2.5 wt % La promoted TiO₂ such that the molar ratio of Li to Ti was 2. The 2.5% La promoted titania added lithium hydroxide dispersion was continuously mixed while heating until it became paste which was dried overnight at 120° C. and calcined at 700° C. for 4 hr. The adsorbent is designated as Adsorbent H.

### Example 9

The adsorbent was prepared as in Example 8 with the difference being that the 5 wt % La was added to anatase TiO₂ instead of 2.5 wt %. The adsorbent is designated as Adsorbent I.

### Example 10

The adsorbent was prepared as in Example 8 with the difference being that the 10 wt % La was added to anatase TiO₂ instead of 2.5 wt %. The adsorbent is designated as Adsorbent J.

### Example 11

The adsorbent was prepared as in Example 8 with the difference being that the 15 wt % La was added to anatase TiO₂ instead of 2.5 wt %. The adsorbent is designated as Adsorbent K.

### Example 12

(NH₄)₆W₁₂O₃₉*H₂O precursor containing 5 wt % tungsten was dissolved in distilled water and added to anatase TiO₂ dropwise via incipient wetness technique, followed by drying and calcining at 500° C. for 4 hr to obtain 5 wt % W promoted TiO₂. Similarly, LiCO₃ precursor was dispersed in distilled water followed by addition of 5 wt % W promoted TiO₂ such that the molar ratio of Li to Ti was 2. The 5% W promoted titania added lithium hydroxide dispersion was continuously mixed while heating until it became paste which was dried overnight at 120° C. and calcined at 700° C. for 4 hr. The adsorbent is designated as Adsorbent L.

### Example 13

The adsorbent was prepared as in Example 12 with the difference being that the 7.5 wt % W was added to anatase TiO₂ instead of 5 wt %. The adsorbent is designated as Adsorbent M.

### Example 14

The adsorbent was prepared as in Example 12 with the difference being that the 15 wt % W was added to anatase TiO₂ instead of 5 wt %. The adsorbent is designated as Adsorbent N.

### Example 15

SiC₈H₂₀O₄ precursor containing 5 wt % silicon was dissolved in distilled water and added to anatase TiO₂ dropwise via incipient wetness technique, followed by drying and calcining at 500° C. for 4 hr to obtain 5 wt % Si promoted TiO₂. Similarly, Li₂CO₃ precursor was dispersed in distilled water followed by addition of 5 wt % Si promoted TiO₂ such that the molar ratio of Li to Ti was 2. The 5% Si promoted titania added lithium hydroxide dispersion was continuously mixed while heating until it became paste which was dried overnight at 120° C. and calcined at 700° C. for 4 hr. The adsorbent is designated as Adsorbent 0.

### Example 16

The adsorbent was prepared as in Example 15 with the difference being that the 10 wt % Si was added to anatase TiO₂ instead of 5 wt %. The adsorbent is designated as Adsorbent P.

### Example 17

The adsorbent was prepared as in Example 15 with the difference being that the 15 wt % Si was added to anatase TiO₂ instead of 5 wt %. The adsorbent is designated as Adsorbent Q.

### Example 18

Conversion of Li₂TiO₃ (LTO) to H₂TiO₃ (HTO): Lithium elution from the sorbent was conducted in a temperature-controlled stirred tank vessel using an aqueous solution of 0.2 M HCl as the eluent. The LTO form of the adsorbent prepared in examples 1-17 was added to the acid solution, achieving a solids loading of 1 wt %. The mixture was stirred at a constant temperature of 80° C. Afterward, the solution was filtered, and the collected solids were dried overnight at 120° C.

### Example 19

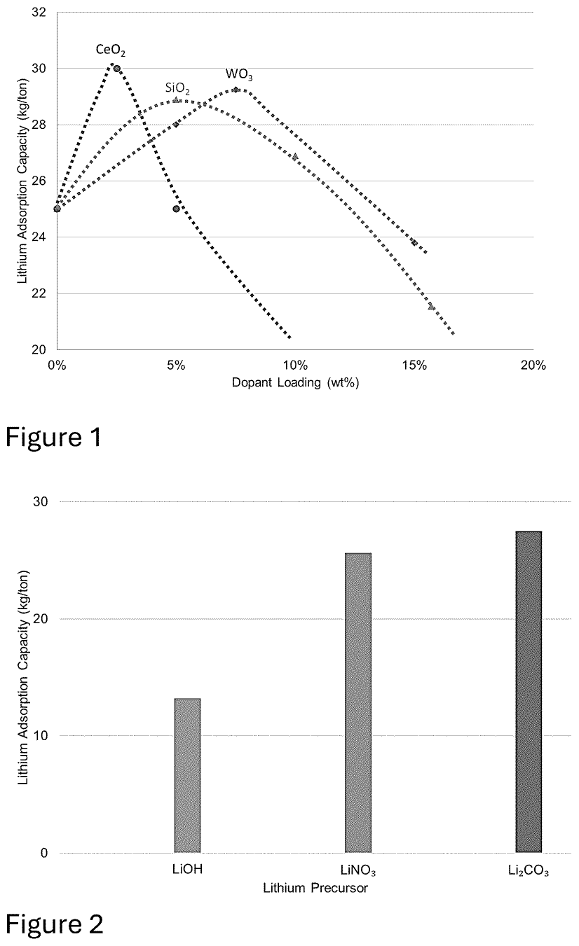

Li+ extraction from brine: Li+ extraction from brine: Lithium extraction experiments were conducted in a temperature controlled stirred tank vessel. KHCO₃ was added to a brine solution containing Lithium to achieve a pH of 8. HTO form of adsorbent prepared in examples 1-17 were added to the brine solution such that the solids loading was 2 wt % and stirred at room temperature. The composition of brine is listed in the Table 1. The result of Li+ extraction from brine is shown in FIG. 1.

TABLE 1
Brine composition used for Example 19

| Ions | Concentration (mg/L) |
|---|---|
| Li⁺ | 1000 |
| Na⁺ | 40,000 |
| K⁺ | 20,000 |
| Mg²⁺ | 20,000 |

### Example 20

Lithium extraction from brine using adsorbents A, B, and C was investigated following the procedure outlined in Examples 18 and 19 to assess the influence of different lithium precursors on the sorbent's extraction efficiency. The results of the tests are presented in FIG. 2. It was observed that adsorbent C, synthesized using Li₂CO₃ salt, exhibited superior performance with a capacity of 28 kg/ton for Li⁺ adsorption compared to adsorbents A and B, which were synthesized using LiNO₃ and LiOH as lithium sources, respectively.

### Example 21

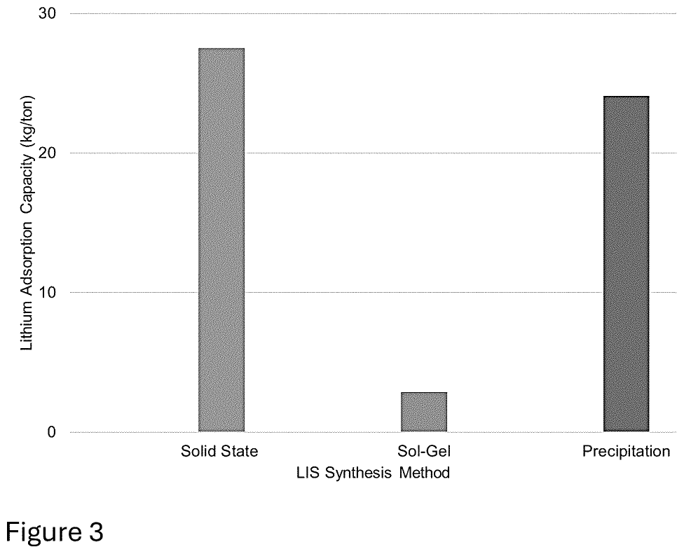

The sorbents were synthesized using various methods: solid-state, sol-gel, and precipitation. The resulting sorbents were tested for lithium extraction using the procedure described in Examples 18 and 19, aimed at identifying the most effective synthesis method for sorbent production. The results of Li⁺ extractions from brine are shown in FIG. 3. The results show that adsorbent which was synthesized by using solid state Method performed better in adsorbing Li⁺ compared to adsorbents, which were synthesized using sol-gel and precipitation methods respectively.

### Example 22

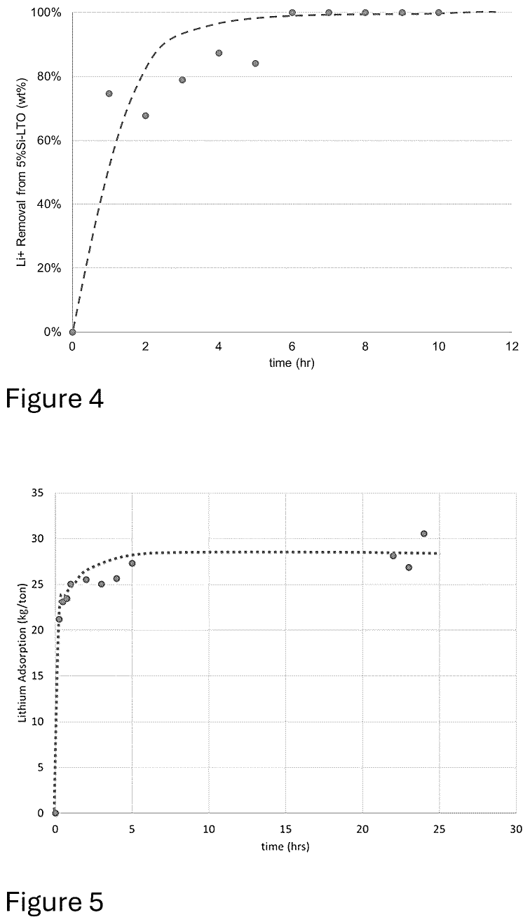

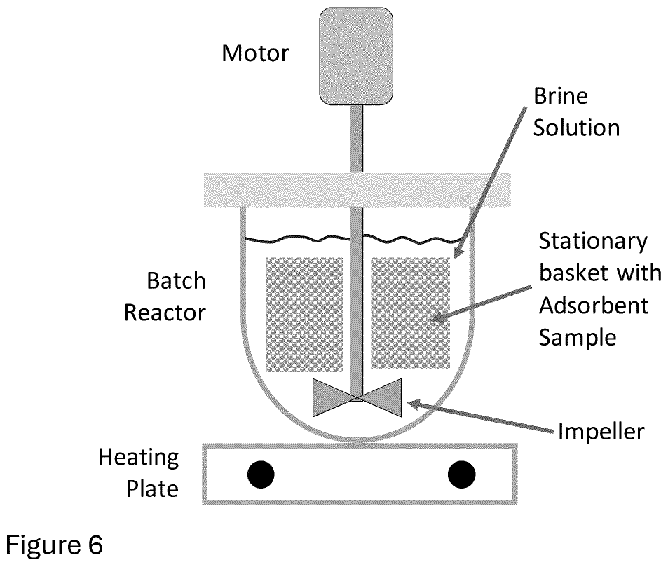

Initial elution of lithium was conducted as described in the Example 18. Samples were taken at regular intervals and analyzed for lithium content. The results are shown in FIG. 4. The graph suggests that the maximum elution of lithium to from HTO is completed within 6 hours of 0.2M HCl treatment.

### Example 23

The lithium extraction experiment was conducted following the procedure outlined in Example 19 using a sorbent synthesized via the solid-state method. Samples were collected at regular intervals to measure the rate of lithium extraction. The results are shown in FIG. 5. The graph suggests that up to 80% of lithium extraction is completed within first two hours and the maximum extraction of lithium is completed within 5 hours.

### Example 24

Polyvinyl Chloride (PVC) powder was dissolved in N-Methylpyrrolidone (NMP); then W-doped lithium titanium oxide (w-LTO) was added, and the slurry was stirred for 10 minutes. The homogeneous slurry was dripped into 400 ml of DI water using syringe to form W-LTO-PVC beads. The adsorbent is designated as Adsorbent R.

### Example 25

The adsorbent was prepared as in Example 24 with the difference being that instead of Polyvinyl Chloride (PVC), Polyvinyl Alcohol (PVA) was used. The adsorbent is designated as Adsorbent S.

### Example 26

The adsorbent was prepared as in Example 24 with the difference being that instead of Polyvinyl Chloride (PVC), Polyvinylidene Difluoride (PVDF) was used. The adsorbent is designated as Adsorbent T.

### Example 27

The adsorbent was prepared as in Example 24 with the difference being that instead of Polyvinyl Chloride (PVC), Polystyrene was used. The adsorbent is designated as Adsorbent U.

### Example 28

The adsorbent was prepared as in Example 24 with the difference being that Polyethylene Glycol (PEG) was added to the slurry to enhance meso-porosity. The adsorbent is designated as Adsorbent V.

### Example 29

The adsorbent was prepared as in Example 27 with the difference being that Polyethylene Glycol (PEG) was added to the slurry to enhance meso-porosity. The adsorbent is designated as Adsorbent W.

### Example 30

The adsorbent was prepared as in Example 24 with the difference being that the LTO used was stabilized by 5% silica. The adsorbent is designated as Adsorbent X.

### Example 31

The adsorbent was prepared as in Example 24 with the difference being that the LTO used was prepared following Example 8. The adsorbent is designated as Adsorbent Y.

### Example 32

Extraction and elution tests were conducted using adsorbent beads prepared as outlined in Examples 24-31. Lithium extraction experiments took place in a temperature-controlled stirred tank vessel. The beads were suspended in a stationary basket while the solution was stirred around them. An aqueous solution of 0.2 M HCl was added to the stirred tank vessel. Adsorbent beads were added to the basket. The acid solution was stirred at a constant temperature of 60° C. After the ion exchange, the adsorbent beads were removed from the acid solution, washed, and stored in deionized water prior to lithium extraction.

### Example 33

Li+ extraction from brine using adsorbent beads: Lithium extraction experiments were conducted in the same experimental set-up described above. 3 wt % KHCO₃ was added to a brine solution containing Lithium to achieve a pH of 8. KHCO₃ added brine was added to the stirred tank vessel containing a basket of HTO form of adsorbent beads prepared in examples 24-31, such that the solids loading was 2 wt %. The experiment was repeated at different temperatures (30° C., 45° C. and 60° C.). Samples were taken at regular intervals to analyze for lithium extraction.

The adsorption of lithium (Li⁺) from the brine solution as a function of time is illustrated in FIG. 7. As shown in the figure, the adsorption of lithium per unit weight of the adsorbent increases with time and reaches its maximum adsorption capacity after approximately 4 hours. Additionally, the adsorption capacity of the adsorbent increases with rising temperature. Specifically, the adsorption capacity is approximately 13.5 mg/g at 30° C., nearly 16 mg/g at 45° C., and 18 mg/g at 60° C. These results indicate that both time and temperature are critical factors in optimizing the adsorption process for lithium recovery.

### Example 34

The LTO adsorbent was converted to bead form using different polymers. The beads were synthesized with Polyvinyl Chloride (PVC), Polyvinyl Alcohol (PVA), Polyvinylidene Difluoride (PVDF), and Polyvinyl Chloride-Polyethylene Glycol (PVC-PEG) polymers resulting in the adsorbents R, S, T, and V respectively. The resulting adsorbents were tested for lithium extraction using the procedures described in Examples 32 and 33, with the aim of identifying the most effective polymer composition for lithium extraction.

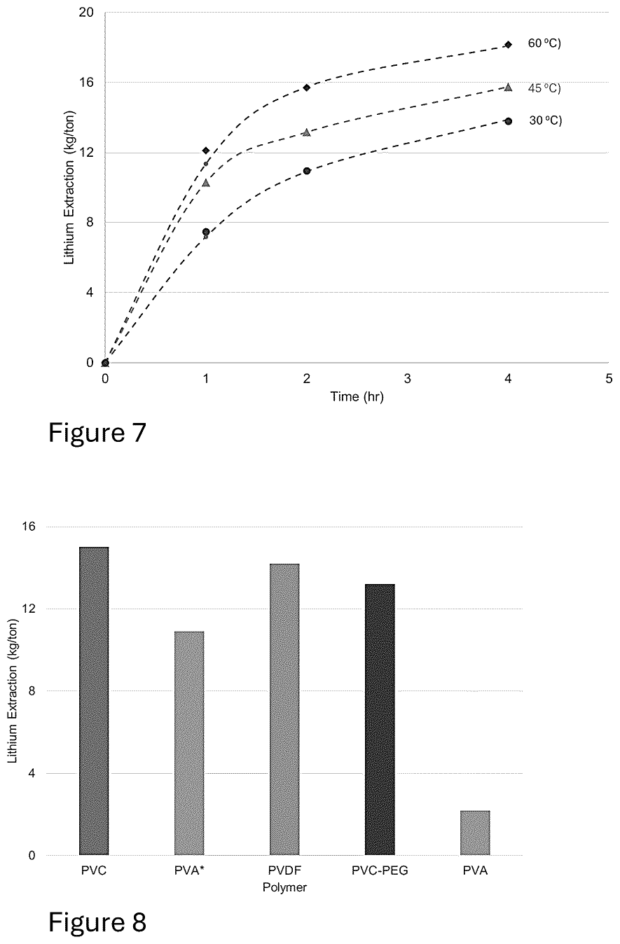

The results of Li⁺ extractions from brine are shown in FIG. 8. The results show that the adsorbent bead synthesized using PVC polymer performed the best, achieving a lithium extraction capacity of 15 kg/ton, compared to those synthesized with PVA, PVDF, and PVC-PEG.

### Example 35

The adsorbents U and W were synthesized as beads using polystyrene and polystyrene with PEG, respectively. These adsorbents were tested for lithium extraction following the procedures described in Examples 32 and 33, with the aim of understanding the effect of adding a pore-forming agent.

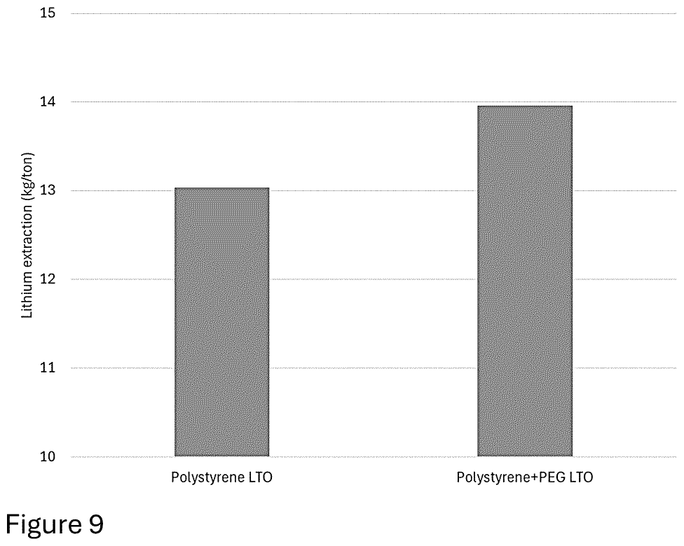

The lithium extraction results from brine are presented in FIG. 9. The findings indicate that the adsorbent bead synthesized using the polystyrene-PEG polymer exhibited superior Li+ adsorption compared to the bead made from polystyrene alone. This suggests that the inclusion of pore-forming agents like PEG introduces mesoporosity, thereby enhancing adsorption capacity.

### Example 36

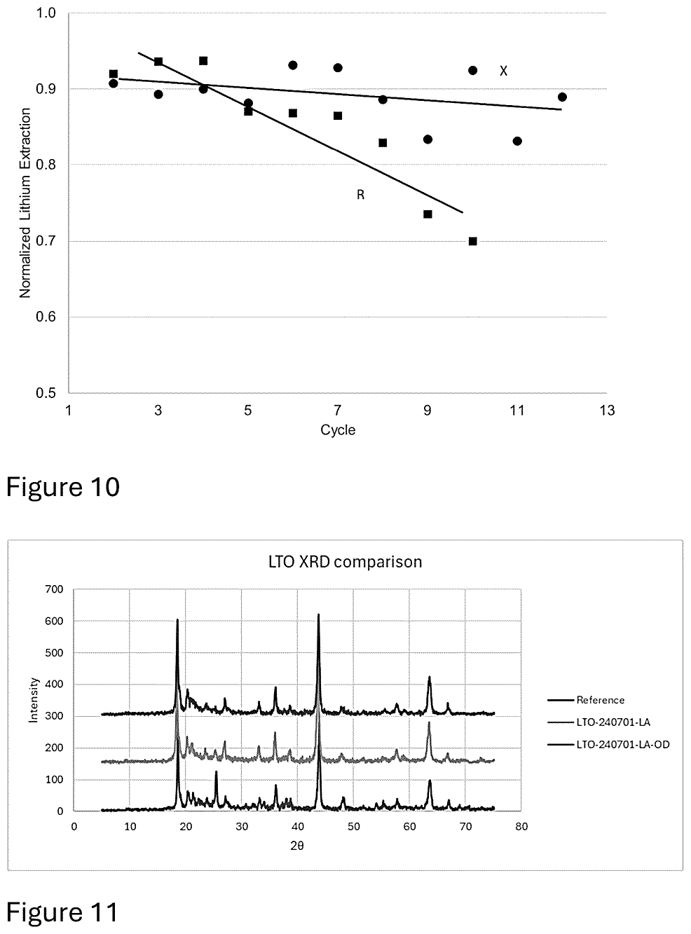

The adsorbents R (LTO) and X (LTSO) were synthesized as beads using PVC and tested for lithium extraction according to the procedures described in Examples 32 and 33. Multiple cycles were conducted to assess their long-term stability. The results are shown in FIG. 10.

The figure shows a gradual decrease in the lithium extraction capacity of the prepared adsorbents, likely due to the loss of Ti⁴⁺ ions during acid treatment. However, the rate of decline is significantly lower for adsorbent X, where the LTO adsorbent is stabilized with silica. Specifically, the LTSO sample shows a decrease in capacity of 0.3% per cycle, while the sample without silica declines at a rate of 3% capacity per cycle. This stability is attributed to a new phase formed by the addition of SiO₂ during synthesis, which is more resistant to dissolution by the mineral acid.

### Example 37

The adsorbents R (LTO) and X (LTSO) were synthesized. To understand the effect of adding SiO₂ to the LTO adsorbents, the samples were characterized using XRD. X-ray diffraction (XRD) is a rapid analytical technique primarily used for phase identification of a crystalline material and can provide information on unit cell dimensions. X-ray diffraction is based on constructive interference of monochromatic X-rays and a crystalline sample. The interaction of the incident rays with the sample produces constructive interference and a diffracted ray. By scanning the sample, all possible diffraction directions of the lattice should be attained due to the random orientation of the powdered material. The diffraction pattern results are shown in FIG. 11.

Comparison of the LTSO XRD pattern to that of the LTO XRD patterns reveals comparable peak intensities at 2θ values of approximately 18.7°, 36.0°, and 43.9°. However, the LTSO XRD pattern exhibits an additional peak in the 2θ range of 20° to 30°, indicating the presence of a unique crystalline phase associated with the LTSO adsorbent. This distinct peak suggests a novel phase formation not observed in the LTO samples, confirming the unique structural properties of the LTSO material.

### Example 38

SiO₂ in the form of Ludox (34% in H₂O) was dispersed in distilled water followed by addition of Li₂CO₃ salt precursor such that the molar ratio of Li to Si was 2. The lithium salt added silica dispersion was continuously mixed while heating until it became a paste which was dried overnight at 120° C. and calcined at 700° C. for 4 hours to obtain Li₂SiO₃ (LSO)

The adsorbent is designated as Adsorbent Z

### Example 39

SiO₂ in the form of Ludox (34% in H₂O) was dispersed in distilled water followed by addition of Li₂CO₃ salt precursor and anatase TiO₂ such that the molar ratio of Ti to Si was 2, molar ratio of Li to Si was 1, and weight ratio of SiO₂ to TiO₂ was 0.33. The lithium salt and TiO₂ added silica dispersion was continuously mixed while heating until it became a paste which was dried overnight at 120° C. and calcined at 700° C. for 4 hours to obtain Li₂SiTiO₅(LTSO)

The adsorbent is designated as Adsorbent AA

### Example 40

Adsorbents C, Z, and AA synthesized as described in Examples C, Z, and AA were slurried in NPM with PVC as described in Example 24 to obtain polymer beads. The adsorbent beads were treated with HCl to convert it to the H-form and then used for lithium extraction from brine following Examples 32 and 33.

### Example 41

The adsorbent was prepared as in Example 39. After calcination at 700° C., the adsorbent was mixed with a silica sol and extruded to form ⅛″ cylindrical pellets. The adsorbent pellets were treated with HCl to convert it to the H-form and then used for lithium extraction from brine following Examples 32 and 33

The lithium extraction results using hydrogen form of LTO, LSO, and LTSO were shown in the Table 2.

TABLE 2
Lithium extraction from brine by hydrogen
form of LTO, LSO, and LTSO

| Adsorbent | Lithium Extraction (mg/g) |
|---|---|
| LTO-PVC | 12 |
| LSO-PVC | 12 |
| LTSO-PVC | 8 |

These results indicate that lithium extraction is not possible without the presence of titanium in the adsorbent matrix, emphasizing the necessity of titanium for forming the active phase with LTO or LTSO. Without titanium, the active phase required for extracting lithium from brine does not form.

### REFERENCES

1. Xu, X.; Chen, Y.; Wan, P.; Gasem, K.; Wang, K.; He, T.; Adidharma, H.; Fan, M. Extraction of lithium with functionalized lithium ion-sieves. Prog. Mater. Sci. 2016, 84, 276-313.
2. T. Ryu, J. Shin, S. M. Ghoreishian, K. S. Chung, and Y. S. Huh, Recovery of lithium in seawater using a titanium intercalated lithium manganese oxide composite, Hydrometallurgy, 184(2019), p. 22.
3. J. S. Yuan, H. B. Yin, Z. Y. Ji, and H. N. Deng, Effective recycling performance of Li+ extraction from spinel-type LiMn2O4 with persulfate, Ind. Eng. Chem. Res., 53(2014), No. 23, p. 9889.
4. R. Pulido, N. Naveas, R. J Martin-Palma, et al., Experimental and density functional theory study of the Li+ desorption in spinel/layered lithium manganese oxide nanocomposites using HCl, Chem. Eng. J., 441(2022), art. No. 136019.
5. J. L. Xiao, X. Y. Nie, S. Y. Sun, X. F. Song, P. Li, and J. G. Yu, Lithium ion adsorption-desorption properties on spinel Li4Mn5O12 and pH-dependent ion-exchange model, Adv. Powder Technol., 26(2015), No. 2, p. 589.
6. J. Chen, S. Lin, and J. G. Yu, Quantitative effects of Fe3O4 nanoparticle content on Li+ adsorption and magnetic recovery performances of magnetic lithium-aluminum layered double hydroxides in ultrahigh Mg/Li ratio brines, J. Hazard. Mater., 388(2020), art. No. 122101.
7. M. P. Paranthaman, L. Li, J. Q. Luo, et al., Recovery of lithium from geothermal brine with lithium-aluminum layered double hydroxide chloride sorbents, Environ. Sci. Technol., 51(2017), No. 22, p. 13481.
8. T. M. Yu, A. Caroline Reis Meira, J. Cristina Kreutz, et al., Exploring the surface reactivity of the magnetic layered double hydroxide lithium-aluminum: An alternative material for sorption and catalytic purposes, Appl. Surf. Sci., 467-468(2019), p. 1195.
9. H. Y. Lin, X. P. Yu, M. L. Li, J. Duo, Y. F. Guo, and T. L. Deng, Synthesis of polyporous ion-sieve and its application for selective recovery of lithium from geothermal water, ACS Appl. Mater. Interfaces, 11(2019), No. 29, p. 26364.
10. M. X. Liu, D. Wu, D. L. Qin, and G. Yang, Spray-drying assisted layer-structured H2TiO₃ ion sieve synthesis and lithium adsorption performance, Chin. J. Chem. Eng., 45(2022), p. 258.
11. S. D. Wei, Y. F. Wei, T. Chen, C. B. Liu, and Y. H. Tang, Porous lithium ion sieves nanofibers: General synthesis strategy and highly selective recovery of lithium from brine water, Chem. Eng. J., 379(2020), art. No. 122407.
12. X. W. Li, L. L. Chen, Y. H. Chao, et al., Highly selective separation of lithium with hierarchical porous lithium-ion sieve microsphere derived from MXene, Desalination, 537(2022), art. No. 115847.
13. R. Marchand, L. Brohan, M. Tournoux, Mater. Res. Bull. 1980, 15, 1129.
14. Z. Yang, D. Choi, S. Kerisit, K. M. Rosso, D. Wang, J. Zhang, G. Graff, J. Liu, J. Power Sources 2009, 192, 588.
15. M. Madian, A. Eychmüller, L. Giebeler, Batteries 2018, 4, 7.
16. M. Wagemaker, W. J. H. H. Borghols, F. M. Mulder, J. Am. Chem. Soc. 2007, 129, 4323.
17. R. van de Krol, A. Goossens, J. Schoonman, J. Phys. Chem. B 1999, 103, 7151.
18. P. Lawagon, G. M. Nisola, J. Mun, A. Tron, R. E. C. Torrejos, J. G. Seo, H. Kim, W.-J. Chung, J. Ind. Eng. Chem. 2016, 35, 347.
19. R. Chitrakar, Y. Makita, K. Ooi, A. Sonoda, Dalton Trans. 2014, 43, 8933
20. D. Gu, W. Sun, G. Han, Q. Cui, H. Wang, Chem. Eng. J. 2018, 350, 474.
21. L. Zhang, D. Zhou, G. He, F. Wang, J. Zhou, Mater. Lett. 2014, 135, 206.
22. Xiaowei Li, Yanhong Chao, Linlin Chen, Wang Chen, Jing Luo, Chao Wang, Peiwen Wu, Huaming Li, Wenshuai Zhu, Chemical Engineering Journal, Volume 392, 2020, 123731
23. G. Zhu, P. Wang, P. Qi, C. Gao, Chem. Eng. J. 235 (2014)340-348.
24. L. W. Ma, B. Z. Chen, Y. Chen, X. C. Shi, Microporous Mesoporous Mater. 142 (2011) 147-153.
25. Y. Zhang, J. Liu, Y. Yang, S. Lin, P. Li, Sep. Purif. Technol. 2021, 267, 118613.
26. J. Liu, Y. Zhang, Y. Miao, Y. Yang, P. Li, Ind. Eng. Chem. Res. 2021, 60, 16457.
27. H. Lin, X. Yu, M. Li, J. Duo, Y. Guo, T. Deng, ACS Appl. Mater. Interfaces 2019, 11, 26364.
28. S. Chen, Z. Chen, Z. Wei, J. Hu, Y. Guo, T. Deng, Chem. Eng. J. 2021, 410, 128320.
29. S. M. Hossain, I. Ibrahim, Y. Choo, A. Razmjou, G. Naidu, L. Tijing, J.-H. Kim, H. K. Shon, Desalination 2022, 525, 115491.
30. Q. H. Zhang, S. P. Li, S. Y. Sun, X. S. Yin, J. G. Yu, Chem. Eng. Sci. 2010, 65, 165.
31. M. Moazeni, H. Hajipour, M. Askari, M. Nusheh, Mater. Res. Bull. 2015, 61, 70.
32. A. Shoghi, S. Ghasemi, M. Askari, A. Khosravi, A. Hasan-Zadeh, A. A. Alamolhoda, J. Environ. Chem. Eng. 2021, 9, 104679.
33. N. Li, D. Lu, J. Zhang, L. Wang, J. Colloid Interface Sci. 2018, 520, 33.
34. X. Zhu, H. Yue, W. Sun, L. Zhang, Q. Cui, H. Wang, Sep. Purif. Technol. 2021, 274, 119099.
35. D. Gu, W. Sun, G. Han, Q. Cui, H. Wang, Chem. Eng. J. 2018, 350, 474.
36. X. Li, L. Chen, Y. Chao, W. Chen, J. Luo, J. Xiong, F. Zhu, X. Chu, H. Li, W. Zhu, Chem. Eng. Technol. 2020, 43, 1784.
37. Z.-Y. Ji, F.-J. Yang, Y.-Y. Zhao, J. Liu, N. Wang, J.-S. Yuan, Chem. Eng. J. 2017, 328, 768.
38. L. M. Rozhdestvenska, M. O. Chaban, Y. S. Dzyazko, O. V. Palchik, O. G. Dzyazko, Appl. Nanosci. 2021, 1, 3.
39. L. Zhang, D. Zhou, G. He, Q. Yao, F. Wang, J. Zhou, Mater. Lett. 2015, 145, 351.
40. L. Zhang, D. Zhou, G. He, F. Wang, J. Zhou, Mater. Lett. 2014, 135, 206.
41. N. Li, K. Gan, D. Lu, J. Zhang, L. Wang, Res. Chem. Intermed. 2018, 44, 1105.
42. Luisa Baudino, Cleis Santos, Candido F. Pirri, Fabio La Mantia, Andrea Lamberti, Adv. Sci. 9, 27, 2022, 2201380
43. X. Xu, Y. Chen, P. Wan, K. Gasem, K. Wang, T. He, H. Adidharma, M. Fan, Prog. Mater. Sci. 2016, 84, 276.
44. D. Weng, H. Duan, Y. Hou, J. Huo, L. Chen, F. Zhang, J. Wang, Prog. Nat. Sci.: Mater. Int. 2020, 30, 139.
45. A. V. Besserguenev, A. M. Fogg, R. J. Francis, S. J. Price, D. O'Hare, V. P. Isupov, B. P. Tolochko,
Chem. Mater. 1997, 9, 241.
46. A. M. Fogg, D. O'Hare, Chem. Mater. 1999, 11, 1771.
47. V. P. Isupov, N. P. Kotsupalo, A. P. Nemudry, L. T. Menzeres, in Adsorption and its Applications in Industry and Environmental Protection, Studies in Surface Science and Catalysis (Ed: A. Dąbrowski), Elsevier B. V., Amsterdam 1999, pp. 621-652.
48. W. T. Stringfellow, P. F. Dobson, Energies 2021, 14, 6805.
49. J. Zhong, S. Lin, J. Yu, J. Colloid Interface Sci. 2020, 572, 107.
50. J. Zhong, S. Lin, J. Yu, Desalination 2021, 505, 114983.
51. X. Xu, Y. Chen, P. Wan, K. Gasem, K. Wang, T. He, H. Adidharma, M. Fan, Prog. Mater. Sci. 2016, 84, 276.
52. D. Weng, H. Duan, Y. Hou, J. Huo, L. Chen, F. Zhang, J. Wang, Prog. Nat. Sci.: Mater. Int. 2020, 30, 139.
53. K. Ooi, Y. Miyai, S. Katoh, H. Maeda, M. Abe, Bull. Chem. Soc. Jpn. 1988, 61, 407.
54. K. Ooi, Y. Miyai, J. Sakakihara, Langmuir 1991, 7, 1167.
55. Q. Feng, Y. Miyai, H. Kanoh, K. Ooi, Langmuir 1992, 8, 1861.
56. H. J. Park, N. Singhal, E. H. Jho, Water Res. 2015, 87, 320.
57. L. Wang, C. G. Meng, W. Ma, Colloids Surf., A 2009, 334, 34.
58. R. Chitrakar, H. Kanoh, Y. Miyai, K. Ooi, Ind. Eng. Chem. Res. 2001, 40, 2054.
59. Q. H. Zhang, S. P. Li, S. Y. Sun, X. S. Yin, J. G. Yu, Adv. Powder Technol. 2009, 20, 432.
60. L. Liu, H. Zhang, Y. Zhang, D. Cao, X. Zhao, Colloids Surf., A 2015, 468, 280.
61. H. J. Hong, I. S. Park, T. Ryu, J. Ryu, B. G. Kim, K.-S. Chung, Chem. Eng. J. 2013, 234, 16.
62. W. Ding, J. Zhang, Y. Liu, Y. Guo, T. Deng, X. Yu, Chem. Eng. J. 2021, 426, 131689.
63. T. Ryu, Y. Haldorai, A. Rengaraj, J. Shin, H.-J. Hong, G.-W. Lee, Y.-K. Han, Y. S. Huh, K.-S. Chung, Ind. Eng. Chem. Res. 2016, 55, 7218.
64. Y. Wang, J. Xu, X. Xu, D. Yang, X. Zheng, J. Pan, T. Zhang, F. Qiu, C. Li, Appl. Organomet. Chem. 2018, 32, e4182.
65. Y. Onodera, T. Iwasaki, H. Hayashi, K. Torii, Chem. Lett. 1990, 19, 1801.
66. L. Liu, H. Zhang, Y. Zhang, D. Cao, X. Zhao, Colloids Surf., A 2015, 468, 280.
67. L.-W. Ma, B.-Z. Chen, Y. Chen, X.-C. Shi, Microporous Mesoporous Mater. 2011, 142, 147.
68. G. M. Nisola, L. A. Limjuco, E. L. Vivas, C. P. Lawagon, M. J. Park, H. K. Shon, N. Mittal, I. W. Nah, H. Kim, W.-J. Chung, Chem. Eng. J. 2015, 280, 536.
69. Y. Han, H. Kim, J. Park, Chem. Eng. J. 2012, 210, 482.
70. Y. Han, S. Kim, H. Kim, J. Park, J. Am. Ceram. Soc. 2011, 94, 2742.
71. S. H. Park, Y.-Z. Yan, J. Kim, C.-S. Ha, S. J. Lee, Hydrometallurgy 2022, 208, 105812.
72. S. H. Park, S. J. Lee, Green Energy Environ. 2022, 7, 334.
73. G. Zhu, P. Wang, P. Qi, C. Gao, Chem. Eng. J. 2014, 235, 340.
74. A. Umeno, Y. Miyai, N. Takagi, R. Chitrakar, K. Sakane, K. Ooi, Ind. Eng. Chem. Res. 2002, 41, 4281.
75. M. Cheng, C. Yao, Y. Su, J. Liu, L. Xu, S. Hou, Chemosphere 2021, 279, 130487.
76. L. Tang, S. Huang, Y. Wang, D. Liang, Y. Li, J. Li, Y. Wang, Y. Xie, W. Wang, ACS Appl. Mater. Interfaces 2020, 12, 9775.
77. Z. Qiu, M. Wang, Y. Chen, T. Zhang, D. Yang, F. Qiu, Desalination 2021, 506, 115003.
78. K. Ding, G. Zhu, C. Song, Q. Wang, L. Wang, Z. Wang, C. Meng, C. Gao, Sep. Purif. Technol. 2022, 284, 120242.
79. M. J. Park, G. M. Nisola, A. B. Beltran, R. E. C. Torrejos, J. G. Seo, S.-P. Lee, H. Kim, W.-J. Chung, Chem. Eng. J. 2014, 254, 73.
80. K. Zhao, B. Tong, X. Yu, Y. Guo, Y. Xie, T. Deng, Chem. Eng. J. 2022, 430, 131423.
81. M. J. Park, G. M. Nisola, E. L. Vivas, L. A. Limjuco, C. P. Lawagon, J. G. Seo, H. Kim, H. K. Shon, W.-J. Chung, J. Membr. Sci. 2016, 510, 141.
82. R. Chitrakar, Y. Makita, K. Ooi, A. Sonoda, Bull. Chem. Soc. Jpn. 2013, 86, 850.
83. R. Chitrakar, Y. Makita, K. Ooi, A. Sonoda, Ind. Eng. Chem. Res. 2014, 53, 3682.
84. X. Dai, H. Zhan, Z. Qian, J. Li, Z. Liu, Z. Wu, RSC Adv. 2021, 11, 34988.
85. S. Zhou, X. Guo, X. Yan, Y. Chen, W. Lang, Particuology 2022, 69, 100.
86. Wang, S., M. Zhang, Y. Zhang, Y. Zhang, S. Qiao, and S. Zheng 2019. Hydrometallurgy 187:30-37.
87. Marthi, R., H. Asgar, G. Gadikota, and Y. R. Smith. 2021. ACS Applied Materials & Interfaces 13:8361-69.
88. Reich R, Slunitschek K, Danisi R M et al (2022) Miner Process Extr Metall Rev.
89. Hawash, S., E. Abd El Kader, and G. El Diwani. 2010. Journal of American Science 6:301-09.
90. Pauwels, H., M. Brach, and C. Fouillac. 1990. Geochimica et Cosmochimica Acta 57:2737-2749.
91. Bajestani, M. B., A. Moheb, and M. Masigol. 2019. Industrial & Engineering Chemistry Research 58:12207-15.
92. Ohashi, F., and Y. Tai. 2019. Materials Letters 251:214-17.
93. Tian, L., W. Ma, and M. Han 2010. Chemical Engineering Journal 156:134-40.
94. Li, L., W. Qu, F. Liu, T. Zhao, X. Zhang, R. Chen, and F. Wu. 2014. Applied Surface Science 315:59-65.
95. Chitrakar, R., Y. Makita, K. Ooi, and A. Sonoda. 2014. Industrial & Engineering Chemistry Research 53:3682-88.
96. Hirano M, Nakahara N, Ota K, Tanaike O, Inagaki N (2003) J Solid State Chem 170:39
97. Kim J, Song K C, Foncillas S, Pratsinis S (2001) J Eur Ceram Soc 21:2863
98. Akhtar M K, Pratsinis S E, Mastrangelo S V R (1992) J Am Ceram Soc 75:3408
99. Chen C H, Kelder E M, Schoonman J (1999) Thin Solid Films 342:35
100. Reidy D J, Holmes J D, Morris M A (2006) Ceram Int 32:235
101. Yang J, Ferreira J M F (1998) Mater Lett 36:320
102. Okada K, Yamamoto N, Kameshima Y, Yasumori A (2001) J Am Ceram Soc 84:1591
103. Franch M, Peral J, Domenech X, Ayllon J A (2005) Chem Commun 14:1851
104. Shannon R D, Pask J A (1965) J Am Ceram Soc 48:391
105. Vargas S, Arroyo R, Haro E, Rodriguez R (1999) J Mater Res 14:3932
106. Mackenzie K J D (1975) Trans J Br Ceram Soc 74:77
107. MacKenzie K J D (1975) Trans J Br Ceram Soc 74:29
108. Yang Y, Li X, Chen J, Wang L (2004) J Photochem Photobiol A 163:517
109. Roy, B.; Ahrenkiel, S. P.; Fuierer, P. A., J. Am. Ceram. Soc. 2008, 91 (8), 2455-2463.
110. Asahi, R.; Morikawa, T.; Ohwaki, T.; Aoki, K.; Taga, Y., Science (Washington, D C, U. S.) 2001, 293 (5528), 269-271.
111. Dong, L.; Cao, G.-x.; Ma, Y.; Jia, X.-I.; Ye, G.-t.; Guan, S.-k., Trans. Nonferrous Met. Soc. China 2009, 19 (6), 1583-1587.
112. Yu, J. C.; Yu, J. G.; Ho, W. K.; Jiang, Z. T.; Zhang, L. Z., Chem. Mater. 2002, 14 (9), 3808-3816.
113. Sakthivel, S.; Kisch, H., Angew. Chem., Int. Ed. 2003, 42 (40), 4908-4911.
114. Sakthivel, S.; Kisch, H., ChemPhysChem 2003, 4 (5), 487-490.
115. Ang, T. P.; Toh, C. S.; Han, Y.-F., J. Phys. Chem. C 2009, 113 (24), 10560-10567.
116. Raj, K. J. A.; Ramaswamy, A. V.; Viswanathan, B., J. Phys. Chem. C 2009, 113 (31), 13750-13757.
117. Bian, Z.; Zhu, J.; Li, H., Stud. Surf. Sci. Catal. 2007, 165 (Recent Progress in Mesostructured Materials), 317-322.
118. Periyat, P.; Baiju, K. V.; Mukundan, P.; Pillai, P. K.; Warrier, K. G. K., Appl. Catal., A 2008, 349 (1-2), 13-19.
119. Sibu, C. P.; Kumar, S. R.; Mukundan, P.; Warrier, K. G. K., Chem. Mater. 2002, 14 (7), 2876-2881.
120. Li, J.-G.; Buchel, R.; Isobe, M.; Mori, T.; Ishigaki, T., J. Phys. Chem. C 2009, 113 (19), 8009-8015.
121. Yang, J.; Ferreira, J. M. F., Mater. Res. Bull. 1998, 33 (3), 389-394.
122. Kim, J.; Song, K. C.; Foncillas, S.; Pratsinis, S. E., J. Eur. Ceram. Soc. 2001, 21 (16), 2863-2872.
123. Prasad, G. K.; Singh, B.; Ganesan, K.; Batra, A.; Kumeria, T.; Gutch, P. K.; Vijayaraghavan, R., J. Hazard. Mater. 2009, 167 (1-3), 1192-1197.
124. E I-Bahy, Z. M.; Ismail, A. A.; Mohamed, R. M., J. Hazard. Mater. 2009, 166 (1), 138-143.
125. Choi, W.; Termin, A.; Hoffmann, M. R., J. Phys. Chem. 1994, 98 (51), 13669-79.
126. Wang, C.; Ao, Y.; Wang, P.; Hou, J.; Qian, J.; Zhang, S., J. Hazard. Mater. 2010, 178 (1-3), 517-521.
127. Hanaor, D. A. H., Sorrell, C. C. J Mater Sci 46, 855-874 (2011).
128. Yang, J.; Ferreira, J. M. F., Mater. Lett. 1998, 36 (5-6), 320-324.
129. Yang, J.; Ferreira, J. M. F., Mater. Res. Bull. 1998, 33 (3), 389-394.
130. Kim, J.; Song, K. C.; Foncillas, S.; Pratsinis, S. E., J. Eur. Ceram. Soc. 2001, 21 (16), 2863-2872.
131. Venezia A M, Palmisano L, Schiavello M (1995) J Solid State Chem 114:364
132. Riyas S, Krishnan G, Mohandas P N (2007) Adv Appl Ceram 106:255
133. Zhang, Hengzhong & Banfield, Jillian. (2000). Journal of Materials Research. 15. 437-448.
134. Penn R L, Banfield J F (1999) Am Miner 84:871
135. Shannon R D, Pask J A (1965) J Am Ceram Soc 48:391
136. Zhang, H.; Banfield, J. F., J. Phys. Chem. B 2000, 104 (15), 3481-3487.
137. G. Nuspl, K. Yoshizawa, T. Yamabe, J. Mater. Chem. 1997, 7, 2529.
138. Z. Yang, D. Choi, S. Kerisit, K. M. Rosso, D. Wang, J. Zhang, G. Graff, J. Liu, J. Power Sources 2009, 192, 588.
139. D.-H. Lee, B.-H. Lee, A. K. Sinha, J.-H. Park, M. Kim, J. Park, H. Shin, K. Lee, Y. Sung, T. Hyeon, J. Am. Chem. Soc. 2018, 140, 16676.
140. Xiaowei Li, Yanhong Chao, Linlin Chen, Wang Chen, Jing Luo, Chao Wang, Peiwen Wu, Huaming Li, Wenshuai Zhu, Chemical Engineering Journal, Volume 392, 2020, 123731
141. A. Ivanets, E. Bicheva, V. Prozorovich, T. Kouznetsova, I. O. Aimbetova, X. Su, “Effect of Ti-containing precursors on structure and adsorption performance of Li₄Ti₅O₁₂ and Li₂TiO₃ oxides to Li⁺ ions,” Separation and Purification Technology, vol. 335, p. 125986, 2024.
142. Z.-Y. Ji, F.-J. Yang, Y.-Y. Zhao, J. Liu, N. Wang, J.-S. Yuan, “Preparation of titanium-based lithium ionic sieve with sodium persulfate as eluent and its performance,” Chemical Engineering Journal, vol. 328, pp. 768-775, 2017.
143. H. Qian, S. Huang, Z. Ba, W. Wang, F. Yu, D. Liang, Y. Xie, Y. Wang, Y. Wang, “HTO/Cellulose Aerogel for Rapid and Highly Selective Li⁺ Recovery from Seawater,” Molecules, vol. 26, p. 4054, 2021.
144. B. Zhao, M. Guo, F. Qian, Z. Qian, N. Xu, Z. Wu, Z. Liu, “Hydrothermal synthesis and adsorption behavior of H₄Ti₅O₁₂ nanorods along [100] as lithium ion-sieves,” RSCAdvances, vol. 10, pp. 35153, 2020.

1. A method of synthesizing an engineered adsorbent material for the selective extraction of lithium ions from liquid brines comprising a sorbent composition having the chemical formula Li_{A}Ti_{B}Si_{C}O_{D}, where A ranges from of 1 to 5, B from 1 to 6, C from 1 to 3 and D from 4 to 20, comprising:
combining a silica source with a lithium salt, a dopant stabilized titanium dioxide and water to form a slurry, drying to form a solid and calcining the solid to obtain a Lithiated adsorbent precursor, and
comprising the steps of either:
a. adding an inorganic binder to the Lithiated adsorbent precursor to form a slurry, extruding the slurry to produce pellets, drying and calcining to form calcined pellets, and acid washing the calcined pellets to obtain an active H-form of the adsorbent; or
b preparing an organic solution with an organic polymeric binder, making a slurry of the Lithiated adsorbent precursor with the organic solution; adding the slurry into deionized water to obtain porous composite; and acid washing the porous composite to obtain the active H-form of the adsorbent.

2. The method of synthesizing an engineered adsorbent material according to claim 1 wherein the engineered adsorbent material is characterizable by Lithium Adsorption Capacity >10 kg/ton Adsorbent, using a test where the engineered adsorbent is exposed to a brine solution for a period of 24 hrs at room temperature containing Lithium ions with a concentration >500 ppm such that the adsorbent loading is 2 wt % of the total solution, and the pH of the solution is adjusted to 8.

3. The method of synthesizing an engineered adsorbent material according to claim 1 wherein the engineered adsorbent material is characterizable by an XRD pattern displaying typical LTO peaks with prominent peak in the 20 range of 20° to 30°, indicative of an LTSO phase having a height (or integrated intensity) that is at least 15% of the largest LTO peak.

4. The method of synthesizing an engineered adsorbent material according to claim 1 wherein the source of lithium is one or a combination of two or more of lithium hydroxide, lithium sulfate, lithium chloride, lithium acetate, lithium propionate, lithium nitrate, lithium hydroxide monohydrate, lithium acetate dihydrate, lithium carbonate and lithium oxalate.

5. The method of synthesizing an engineered adsorbent according to claim 1 wherein the dopant to stabilize Titanium Dioxide is selected from a cation group of cerium (Ce), lanthanum (La), dysprosium (Dy), erbium (Er), aluminum (Al), barium (Ba), calcium (Ca), strontium (Sr), niobium (Nb), iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or mixtures thereof.

6. The method of synthesizing an engineered adsorbent according to claim 1 wherein the source of silica comprises one or more of: organosilicon compounds, fumed silica, colloidal silica, suspensions of colloidal silica, sodium silicate, silicic acid, precipitated silica, pyrogenic silica, rice husk ash, fly ash, silica gel, zeolites, siliceous sand, amorphous silica, biogenic silica, mesoporous silica, silicate minerals, quartz, glass, diatomaceous earth, volcanic ash, natural silica-rich rocks, synthetic silicates or mixtures thereof.

7. The method of synthesizing an engineered adsorbent according to claim 1 comprising adding an inorganic binder wherein the inorganic binder is selected from: alumina (Al₂O₃), silica (SiO₂), zinc oxide (ZnO), and zirconia (ZrO₂), or mixtures thereof.

8. The method of synthesizing an engineered adsorbent according to claim 1 comprising adding an organic polymeric binder wherein the organic polymeric binder is selected from a list of polymers or co-polymers like PVB (Polyvinyl butyral), EVA (Ethylene-vinyl acetate), PMMA (Polymethyl methacrylate), PVC (Polyvinyl chloride), PET (Polyethylene terephthalate), PU (Polyurethane), PE (Polyethylene), ABS (Acrylonitrile-butadiene-styrene), PS (Polystyrene), PP (Polypropylene), PC (Polycarbonate), PTFE (Polytetrafluoroethylene), ETFE (Ethylene tetrafluoroethylene), PA (Polyamide/Nylon), PEEK (Polyether ether ketone), PLA (Polylactic acid), PPS (Polyphenylene sulfide), POM (Polyoxymethylene), PVDF (Polyvinylidene fluoride), SAN (Styrene-acrylonitrile copolymer) or mixtures thereof where the support amount varies from 5 to 50 wt % of the adsorbent.

9. The method of synthesizing an engineered adsorbent according to claim 1 with a chemical formula LiaTibSicOd, wherein the doped Titanium Dioxide is prepared by adding salts of cerium (Ce), lanthanum (La), dysprosium (Dy), erbium (Er), aluminum (Al), barium (Ba), calcium (Ca), strontium (Sr), niobium (Nb), iron (Fe), manganese (Mn), silver (Ag), chromium (Cr), praseodymium (Pr), samarium (Sm), terbium (Tb), ytterbium (Yb), yttrium (Y) Tungsten (W) and zirconium (Zr) or mixtures thereof to dry anatase powder followed by drying and calcination

10. The method of synthesizing an engineered adsorbent according to claim 1 with a chemical formula LiaTibSicOd, wherein the doped Titanium Dioxide is prepared by dissolving salts of Titanium with soluble salts of dopants, co-precipitating the salts from the solution using a precipitating agent followed by drying and calcination

11. The method of synthesizing an engineered adsorbent according to claim 1 with a chemical formula LiaTibSicOd, wherein the doped Titanium Dioxide is prepared by dissolving organic alkoxides of titanium and dopant salts in an organic solvent, hydrolyzing the solution using either an aqueous solution of mineral acid or base to obtain a composite precursor, drying and calcining to obtain the doped Titanium Dioxide.

12. The method of synthesizing an engineered adsorbent according to claim 1 wherein the calcining step to obtain a doped Titanium Dioxide is conducted at a temperature greater than 450° C.

13. The method of synthesizing an engineered adsorbent according to claim 1 wherein the inorganic or polymeric binder comprises from 5 to 50 wt % of the final adsorbent.

14. The method of synthesizing an engineered adsorbent according to claim 1 wherein the volume average pore diameter of the adsorbent is in the range of 3-1000 nanometers.

15. The method of synthesizing an engineered adsorbent according to claim 1 wherein the average particle diameter of the adsorbent is in the range of 1-3 mm.

16. The method of synthesizing an engineered adsorbent according to claim 1 wherein the BET surface area is at least 10 m²/g.

17. The method of synthesizing an engineered adsorbent according to claim 1 wherein the calcining step to obtain a Lithiated adsorbent precursor is conducted at a temperature greater than 550° C.

18. The method of synthesizing an engineered adsorbent as defined in claim 1 wherein a biomorphic template is added to the slurry during adsorbent synthesis step to generate a mesoporous solid.

19. The method according to claim 18 wherein biomorphic templates are selected from one or a combination of two or more of xylose, glucose, cellobiose, oligomer of C5-C6 sugars, cellulose, soluble starch, sorghum straw and microalgae.
